(19) United States
(12) Patent Application Publication
(10) Pub. No.: US 2025/0097829 A1
(43) Pub. Date: Mar. 20, 2025

(54) MANAGING SYSTEM INFORMATION COMMUNICATION IN SMALL DATA TRANSMISSION

(71) Applicant: GOOGLE LLC, Mountain View, CA (US)

(72) Inventor: Chih-Hsiang Wu, Taoyuan City (TW)

(21) Appl. No.: 18/727,530

(22) PCT Filed: Jan. 10, 2023
(86) PCT No.: PCT/US23/10446

§ 371 Date: Jul. 9, 2024

Related U.S. Application Data
(60) Provisional application No. 63/356,254, filed on Jun. 28, 2022.
(60) Provisional application No. 63/298,200, filed on Jan. 10, 2022.

(51) Int. Cl. H04W 48/14; H04W 74/08

(52) U.S. Cl. CPC H04W 48/14; H04W 74/08

(57) ABSTRACT

A user equipment (UE) performs a method of obtaining system information. The method includes disabling (328) a system information request function of the UE while the UE is in an inactive state and, while the system information request function is disabled and the UE is in the inactive state, communicating (316) with a radio access network (RAN) using small data transmission (SDT). The method also includes enabling (330) the system information request function of the UE when the UE is no longer communicating with the RAN using SDT.

### FIELD OF THE DISCLOSURE

This disclosure relates generally to wireless communications and, more particularly, to managing the request, transmission, and reception of system information for a user equipment (UE) and a radio access network (RAN), e.g., when the UE operates in an inactive or idle state associated with a protocol for controlling radio resources and communicates uplink and/or downlink data with the RAN.

### BACKGROUND

This background description is provided for the purpose of generally presenting the context of the disclosure. Work of the presently named inventors, to the extent it is described in this background section, as well as aspects of the description that may not otherwise qualify as prior art at the time of filing, are neither expressly nor impliedly admitted as prior art against the present disclosure.

Generally, a base station operating in a cellular radio access network (RAN) communicates with a user equipment (UE) using a certain radio access technology (RAT) and multiple layers of a protocol stack. For example, the physical layer (PHY) of a RAT provides transport channels to the Medium Access Control (MAC) sublayer, which in turn provides logical channels to the Radio Link Control (RLC) sublayer, and the RLC sublayer in turn provides data transfer services to the Packet Data Convergence Protocol (PDCP) sublayer. The Radio Resource Control (RRC) sublayer is disposed above the PDCP sublayer.

The RRC sublayer specifies the RRC_IDLE state, in which a UE does not have an active radio connection with a base station; the RRC_CONNECTED state, in which the UE has an active radio connection with the base station; and the RRC_INACTIVE to allow a UE to more quickly transition back to the RRC_CONNECTED state using RAN-level base station coordination and RAN-paging procedures. In some cases, the UE in the RRC_INACTIVE state has only one, relatively small packet to transmit. For situations such as these, 3GPP is discussing a Small Data Transmission (SDT) procedure to enable the 5G NR to support data transmission for the UE operating the RRC_INACTIVE state (i.e., without requiring that the UE transition to the RRC_CONNECTED state).

SDT is enabled on a radio bearer basis and is initiated by the UE only if less than a configured amount of uplink data awaits transmission across all radio bearers for which SDT is enabled, the downlink (DL) reference signal received power (RSRP) is above a configured threshold, and a valid SDT resource is available. An SDT procedure can be initiated by the UE with either a transmission over a random access channel (RACH), i.e., random access SDT (RA-SDT) or over Type 1 configured grant (CG) resources, i.e., CG-SDT. For the RA-SDT, the network configures 2-step and/or 4-step random access resources for SDT. In the RA-SDT, the UE can transmit an initial transmission including data in a message 3 (MSG3) of a 4-step random access procedure or in the payload of a message A (MSGA) of a 2-step random access procedure. The network can then schedule subsequent uplink and/or downlink transmissions for the UE using dynamic uplink grants and downlink assignments, respectively, after completion of the random access procedure.

The CG-SDT can only be initiated with a valid uplink (UL) timing alignment. The UE maintains the UL timing alignment based on a network-configured, SDT-specific timing alignment timer and the DL RSRP of a configured number of highest ranked SSBs. Upon expiry of the SDT-specific timing alignment timer, the CG resources are released. Upon initiating the CG-SDT, the UE transmits an initial transmission including data on a CG occasion using a CG configuration, and the network can schedule subsequent UL transmissions using dynamic grants or on future CG resource occasions. During the CG-SDT, the DL transmissions are scheduled using dynamic assignments. The UE can initiate subsequent UL transmission only after receiving, from the network, confirmation of the initial UL transmission.

However, it is not clear how to efficiently manage the provision of system information from an NG-RAN to a UE in certain situations, particularly if the UE can perform SDT with the NG-RAN, and if the NG-RAN does not periodically broadcast a particular system information block (SIB) or system information message (e.g., for a particular service or operation).

### SUMMARY

According to certain techniques of this disclosure, a UE can request on-demand system information from a RAN when the UE is in a connected state and/or when the UE is in an inactive state without SDT enabled, but refrains from requesting system information (i.e., disables a system information request function) when the UE is in an inactive state with SDT enabled.

In other techniques of this disclosure, a UE can request on-demand system information from a RAN when the UE is in an inactive state with SDT enabled. The UE may request the system information before beginning SDT with the RAN (e.g., immediately after initiating SDT), or may request the system information at some point after SDT has begun, depending on the implementation and/or scenario. In some implementations, the system information request sent by the UE can be an RRC message (e.g., an RRCSystemInfoRequest message or a dedicated RRC message) in a UL media access control (MAC) protocol data unit (PDU). In other implementations, the UE can request system information by sending a random access channel (RACH) message using a particular RACH configuration (e.g., a particular RACH preamble) that is dedicated for the purpose of requesting system information. The RAN may provide requested system information by unicasting the system information to the requesting UE, or by broadcasting system information, depending on the implementation. In some implementations, a DU of a distributed base station directly broadcasts requested system information when receiving a request from a UE that is in an inactive state without SDT enabled but, when instead receiving a request from a UE in a connected state, or from a UE in an inactive state with SDT enabled, the DU instead transmits a DU-to-CU message to request that the CU of the base station unicast the system information to the UE.

As used herein, and unless a more specific meaning is clear from the context of use, the term “data” or “data packet” can refer to signaling, control-plane information at a protocol layer of controlling radio resources (e.g., RRC), controlling mobility management (MM), or controlling session management (SM), or can refer to non-signaling, non-control-plane information at a protocol layer above the layer of the protocol for controlling radio resources (e.g., RRC), above the layer of the protocol for controlling MM, above the layer of the protocol for controlling SM, and/or above the layer of the protocol for controlling quality of service (QOS) flows (e.g., service data adaptation protocol (SDAP)). The data to which the UE and/or the RAN applies the techniques of this disclosure can include, for example, Internet of things (IoT) data, Ethernet traffic data, Internet traffic data, or a short message service (SMS) message, for example. Further, the UE in some implementations applies SDT techniques only if the size of the data is below a certain (e.g., configured) threshold value. It is also understood that, as used herein (and unless the context of its use indicates a more specific meaning), the term “configuration” can refer to a full configuration, or to a subset of parameters of a full configuration (e.g., a “delta” or other partial configuration that can augment an existing configuration without completely replacing the existing configuration).

In one aspect, a method, performed by a UE, of obtaining system information includes disabling a system information request function of the UE while the UE is in an inactive state and, while the function is disabled and the UE is in the inactive state, communicating with a RAN using SDT. The method also includes enabling the system information request function of the UE when the UE is no longer communicating with the RAN using SDT.

### BRIEF DESCRIPTION OF THE DRAWINGS

FIG. 1A is a block diagram of an example wireless communication system in which a radio access network (RAN) and/or a user equipment (UE) can implement the techniques of this disclosure;

FIG. 1B is a block diagram of an example base station, including a central unit (CU) and a distributed unit (DU), that can operate in the RAN of FIG. 1A;

FIG. 2A is a block diagram of an example protocol stack according to which the UE of FIG. 1A can communicate with the RAN of FIG. 1A;

FIG. 2B is a block diagram of an example protocol stack according to which the UE of FIG. 1A can communicate with a DU and a CU of a base station of FIG. 1A or 1B;

FIG. 3A-3H are example message sequences in which a UE, in an inactive state with small data transmission (SDT) enabled, either requests or refrains from requesting on-demand system information from a RAN;

FIG. 4A is a flow diagram of an example method for transmitting a system information request to a RAN while communicating data with the RAN in the inactive state, which can be implemented by the UE of FIG. 1A;

FIG. 4B is a flow diagram of an example method for transmitting a system information request to a RAN while in the inactive state and suspending data transmission with the RAN, which can be implemented by the UE of FIG. 1A;

FIG. 5 is a flow diagram of an example method for disabling or enabling an on-demand system information request function based on whether the UE is in the inactive state with or without SDT, which can be implemented by the UE of FIG. 1A;

FIG. 6 is a flow diagram of an example method for ensuring that a UE in the inactive state is not in data communication when transmitting a system information request to the RAN, which can be implemented by the UE of FIG. 1A;

FIGS. 7 and 8 are flow diagrams of example methods for prioritizing the transmission of an on-demand system information request over data communication with a RAN while a UE is in the inactive state, which can be implemented by the UE of FIG. 1A;

FIGS. 9A and 9B are flow diagrams of example methods for transmitting different requests for on-demand system information depending on whether the UE is configured with SDT, or depending on whether the UE is in the inactive state with SDT enabled, respectively, which can be implemented by the UE of FIG. 1A;

FIG. 10 is a flow diagram of an example method for providing on-demand system information to a UE that is in the inactive state with SDT enabled, which can be implemented by one or more nodes of the RAN of FIG. 1A;

FIGS. 11 and 12 are flow diagrams of example methods for providing on-demand system information to a UE that is in the inactive state with SDT enabled, which can be implemented by a CU (e.g., CU-CP) of FIG. 1B;

FIGS. 13-15 are flow diagrams of example methods for providing system information to a UE via unicast or broadcast depending on various factors, which can be implemented by one or more nodes of the RAN of FIG. 1A;

FIG. 16 is a flow diagram of an example method for providing system information to a UE via unicast or broadcast depending on the state of the UE and/or whether the UE is performing SDT, which can be implemented by a CU (e.g., CU-CP) of FIG. 1B; and

FIG. 17 is a flow diagram of an example method for providing system information to a UE via unicast or broadcast depending on the state of the UE and/or whether the UE is performing SDT, which can be implemented by a DU of FIG. 1B.

### DETAILED DESCRIPTION OF THE DRAWINGS

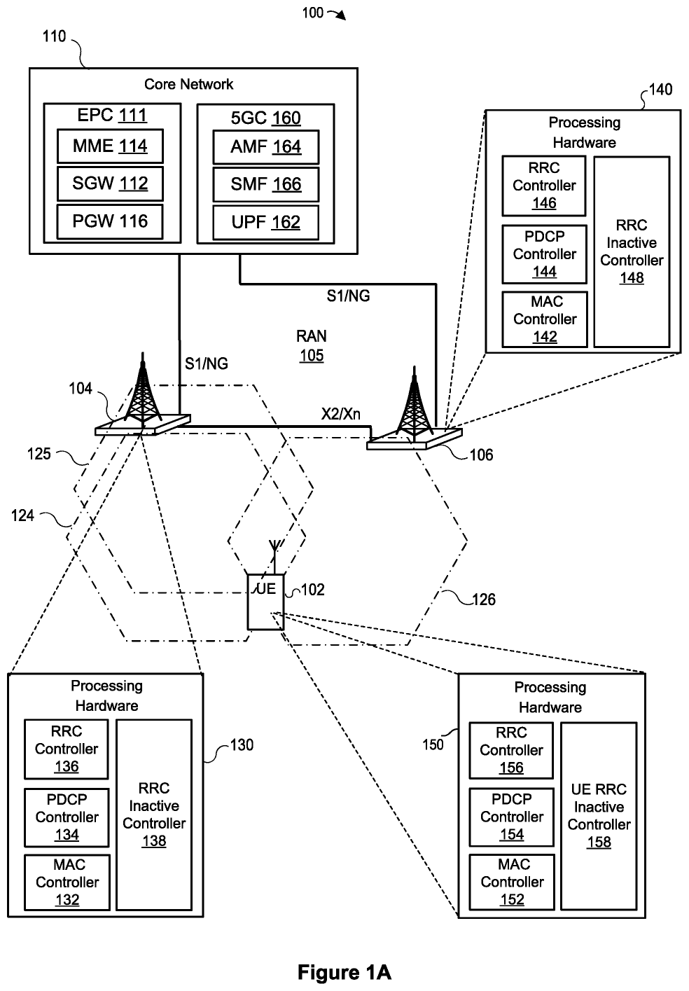

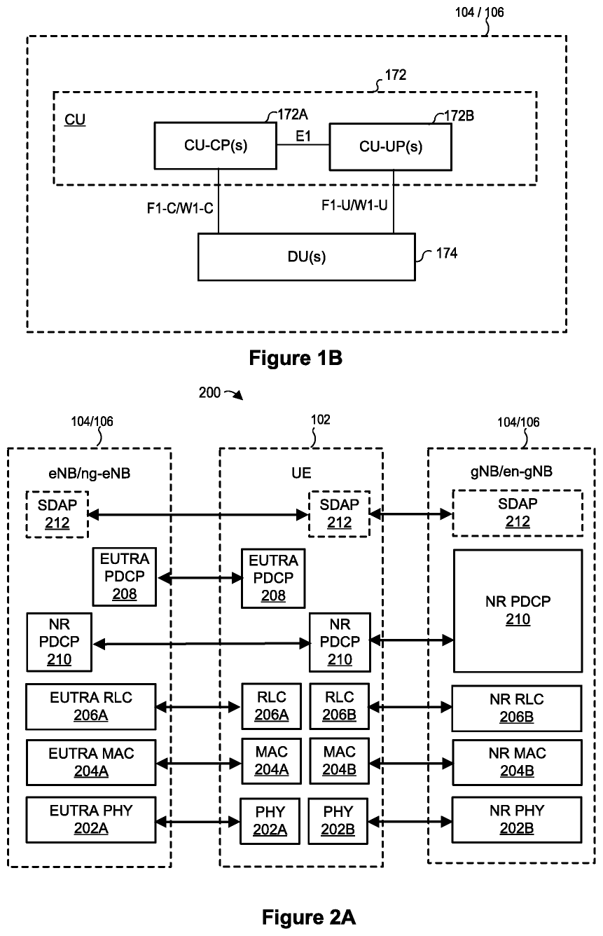

Referring first to FIG. 1A, an example wireless communication system 100 includes a UE 102, a base station (BS) 104, a base station 106, and a core network (CN) 110. The base stations 104 and 106 can operate in a RAN 105 connected to the core network (CN) 110. The CN 110 can be implemented as an evolved packet core (EPC) 111 or a fifth generation (5G) core (5GC) 160, for example. The CN 110 can also be implemented as a sixth generation (6G) core in another example.

The base station 104 can cover one or more cells (e.g., cells 124 and 125), and the base station 106 can similarly cover one or more cells (e.g., cell 126). If the base station 104 is a gNB, the cells 124 and 125 are NR cells. If the base station 104 is an (ng-)eNB, the cells 124 and 125 are evolved universal terrestrial radio access (EUTRA) cells. Similarly, if the base station 106 is a gNB, the cell 126 is an NR cell, and if the base station 106 is an (ng-)cNB, the cell 126 is an EUTRA cell. The cells 124, 125, and 126 can be in the same Radio Access Network Notification Areas (RNA) or different RNAs. In general, the RAN 105 can include any number of base stations, and each of the base stations can cover one, two, three, or any other suitable number of cells. The UE 102 can support at least a 5G NR (or simply, “NR”) or E-UTRA air interface to communicate with the base stations 104 and 106. Each of the base stations 104, 106 can connect to the CN 110 via an interface (e.g., S1 or NG interface). The base stations 104 and 106 also can be interconnected via an interface (e.g., X2 or Xn interface) for interconnecting NG RAN nodes.

Among other components, the EPC 111 can include a Serving Gateway (SGW) 112, a Mobility Management Entity (MME) 114, and a Packet Data Network Gateway (PGW) 116. The SGW 112 in general is configured to transfer user-plane packets related to audio calls, video calls, Internet traffic, etc., and the MME 114 is configured to manage authentication, registration, paging, and other related functions. The PGW 116 provides connectivity from the UE 102 to one or more external packet data networks, e.g., an Internet network and/or an Internet Protocol (IP) Multimedia Subsystem (IMS) network. The 5GC 160 includes a User Plane Function (UPF) 162 and an Access and Mobility Management Function (AMF) 164, and/or Session Management Function (SMF) 166. Generally, the UPF 162 is configured to transfer user-plane packets related to audio calls, video calls, Internet traffic, etc., the AMF 164 is configured to manage authentication, registration, paging, and other related functions, and the SMF 166 is configured to manage PDU sessions.

As illustrated in FIG. 1A, the base station 104 supports cells 124 and 125, and the base station 106 supports a cell 126. The cells 124, 125, and 126 can partially overlap, so that the UE 102 can select, reselect, or hand over from one of the cells 124, 125, and 126 to another. To directly exchange messages or information, the base station 104 and base station 106 can support an X2 or Xn interface. In general, the CN 110 can connect to any suitable number of base stations supporting NR cells and/or EUTRA cells.

As discussed in detail below, the UE 102 can implement the techniques of this disclosure for measuring a carrier frequency as instructed by the RAN 105 without interrupting data communication when the radio connection between the UE 102 and the RAN 105 is suspended, e.g., in the inactive or idle state of the protocol for controlling radio resources between the UE 102 and the RAN 105. For clarity, the examples below refer to the RRC_INACTIVE or RRC_IDLE state of the RRC protocol. As discussed below, the UE 102 in some implementations applies the techniques of this disclosure only if the size of the data (e.g., UL data) is below a certain threshold value.

In the example scenarios discussed below, the UE 102 transitions to the RRC_INACTIVE or RRC_IDLE state, selects a cell of the base station 104, and exchanges data with the base station 104 either via the base station 106 or with the base station 104 directly, without transitioning to the RRC_CONNECTED state. After the UE 102 determines that data is available for UL transmission in the RRC_INACTIVE or RRC_IDLE state, the UE 102 can generally secure the data, include the secured data as a security-protected packet in a first UL PDU, and transmit the first UL PDU to the RAN 105 in a second UL PDU.

As a more specific example, the UE 102 can apply one or more security functions to secure-protect the UL data packet, generate a first UL PDU that includes the security-protected UL data packet, include a UL RRC message along with the first UL PDU in a second UL PDU, and transmit the second UL PDU to the RAN 105. After receiving the second UL PDU, the RAN 105 can identify the UE 102 based on a UE identity/identifier (ID) of the UE 102 that the UE 102 included in the UL RRC message. In some implementations, the UE ID can be an inactive Radio Network Temporary Identifier (I-RNTI), resume ID, or a non-access stratum (NAS) ID. The NAS ID can be an S-Temporary Mobile Subscriber Identity (S-TMSI) or a Global Unique Temporary Identifier (GUTI), in some implementations.

In some implementations, the security function that the UE 102 applied to the UL data packet as discussed above can include an integrity protection and/or encryption function. In applying integrity protection, the UE 102 can generate a message authentication code for integrity (MAC-I) to protect integrity of the data. Thus, the UE 102 in this case generates a security-protected packet that includes the data and the MAC-I. In applying an encryption function, the UE 102 can encrypt the data to obtain an encrypted packet, so that the security-protected packet includes encrypted data. When both integrity protection and encryption are applied, the UE 102 can generate a MAC-I for protecting integrity of the data and encrypt the data along with the MAC-I to generate an encrypted packet and an encrypted MAC-I. The UE 102 then can transmit the security-protected packet to the RAN 105, while still in the RRC_INACTIVE or RRC_IDLE state.

In some implementations, the data described above is a UL service data unit (SDU) of the packet data convergence protocol (PDCP) or SDAP. The UE 102 applies the security function to the SDU and includes the secured SDU in a first UL PDU (e.g., a UL PDCP PDU). The UE 102 then includes the UL PDCP PDU in a second UL PDU such as a UL MAC PDU, which can be associated with the MAC layer. Thus, the UE 102 in these cases transmits the secured UL PDCP PDU in the UL MAC PDU. In some implementations, the UE 102 can include, in the UL MAC PDU, a UL RRC message. In other implementations, the UE 102 may omit a UL RRC message from the UL MAC PDU. In this case, the UE 102 may omit a UE ID from the UE 102 in the UL MAC PDU. In yet other implementations, the UE 102 can include the UL PDCP PDU in a UL radio link control (RLC) PDU and then include the UL RLC PDU in the UL MAC PDU. In some implementations in which the UE 102 includes the UL RRC message in the UL MAC PDU, the UE 102 generates an RRC MAC-I (e.g., resumeMAC-I field, as specified in 3GPP specification 38.331) and includes the RRC MAC-I in the UL RRC message. In other implementations, rather than generating the RRC MAC-I, the UE 102 can obtain the RRC MAC-I from the UL RRC message with an integrity key (e.g., K_{RRCint} key), an integrity protection algorithm, and parameters such as COUNT (e.g., 32-bit, 64-bit or 128-bit value), BEARER (e.g., 5-bit value), and DIRECTION (e.g., 1-bit value).

In other implementations, the data described above is a UL SDU of the NAS. The UE 102 applies the security function to the SDU and includes the secured SDU in a first UL PDU such as a UL NAS PDU, which can be associated with the NAS layer. For example, the NAS layer can be an MM or SM sublayer of 5G, evolved packet system (EPS), or 6G. Then the UE 102 can include the UL NAS PDU in a second UL PDU such as a UL RRC message. The UE 102 in these cases then transmits the (first) secured UL NAS PDU in the UL RRC message. In some implementations, the UE 102 can include the UL RRC message in a UL MAC PDU and transmits the UL MAC PDU to a base station (e.g., base station 104 or 106) via a cell (e.g., cell 124 or 126). The UE 102 may not include an RRC MAC-I in the UL RRC message, or alternatively, include an RRC MAC-I as described above.

In some implementations, the UL RRC message described above can be a common control channel (CCCH) message, an RRC resume request message, or an RRC early data request message. The RRC resume request message can be an existing RRC resume request message (e.g., an RRCResumeRequest message, an RRCResumeRequest1 message, an RRCConnectionResumeRequest message, or an RRCConnectionResumeRequest1 message), or a new RRC resume request message that is similar to the existing RRC resume request message but defined as a format of a RRC release or version later than that of the existing RRC resume request message. In some implementations, the UL RRC message can include a UE ID of the UE 102 as described above.

In some scenarios and implementations in which the UE ID of the UE 102 is included in the UL RRC message as described above, the base station 106 can retrieve the UE ID of the UE 102 from the UL RRC message and identify, based on the determined UE ID, the base station 104 as the destination of the data in the first UL PDU. In one implementation, the base station 106 retrieves the first UL PDU from the second UL PDU and transmits the first UL PDU to the base station 104. The base station 104 then retrieves the security-protected packet from the first UL PDU, applies security function(s) to decrypt the data and/or check the integrity protection, and transmits the data to the CN 110 (e.g., SGW 112, UPF 162, MME 114, or AMF 164) or an edge server (e.g., an edge server that can operate within the RAN 105). More specifically, the base station 104 derives security key(s) from UE context information of the UE 102. The base station 104 then retrieves the data from the security-protected packet by using the security key(s) and transmits the data to the CN 110 or edge server. In another implementation, instead of the base station 104 retrieving the security-protected packet from the first UL PDU, the base station 106 retrieves the security-protected packet from the first UL PDU. More specifically, the base station 106 can perform a retrieve UE context procedure with the base station 104 to obtain UE context information of the UE 102 from the base station 104, and then derive security key(s) from the UE context information. The base station 106 then retrieves the data from the security-protected packet by using the security key(s) and transmits the data to the CN 110 (e.g., UPF 162) or an edge server. In each of these implementations, when the security-protected packet is an encrypted packet, the base station 104 or 106 decrypts the encrypted packet to obtain the data by using the security key(s) (e.g., a (de)encryption key). If the security-protected packet is an integrity-protected packet that includes the data and the MAC-I, the base station 104 or 106 can verify whether the MAC-I is valid for the security-protected packet by using the security key(s) (e.g., an integrity key). When the base station 104 or 106 confirms that the MAC-I is valid, the base station 104 or 106 sends the data to the CN 110 or edge server. On the other hand, when the base station 104 or 106 determines the MAC-I is invalid, the base station 104 or 106 discards the security-protected packet. Further, if the security-protected packet is both encrypted and integrity-protected and therefore includes the encrypted packet along with the encrypted MAC-I, the base station 104 or 106 decrypts the encrypted packet and the encrypted MAC-I to obtain the data and the MAC-I. The base station 104 or 106 then determines whether the MAC-I is valid for the data. If the base station 104 or 106 determines that the MAC-I is valid, the base station 104 or 106 retrieves the data and forwards the data to the CN 110 or edge server. However, if the base station 104 or 106 determines that the MAC-I is invalid, the base station 104 or 106 discards the packet.

In other scenarios and implementations, the base station 104 can retrieve and use the UE ID of the UE 102 from the UL RRC message to determine that the base station 104 stores UE context information of the UE 102. Accordingly, the base station 104 retrieves the security-protected packet from the first UL PDU, retrieves the data from the security-protected packet, and sends the data to the CN 110 or edge server as described above.

Further, in some scenarios and implementations, the RAN 105 transmits data in the DL direction to the UE 102 operating in the RRC_INACTIVE or RRC_IDLE state. In one implementation, when the base station 104 determines that data is available for DL transmission to the UE 102 currently operating in the RRC_INACTIVE or RRC_IDLE state, the base station 104 can secure the data to generate a security-protected packet, generate a first DL PDU that includes the security-protected packet, and include the first DL PDU in a second DL PDU. To secure the data, the base station 104 can apply security function(s) (e.g., integrity protection and/or encryption) to the data. More particularly, similar to the manner in which the UE 102 can secure data available for UL transmission, in applying integrity protection, the base station 104 can generate a MAC-I for protecting integrity of the data available for DL transmission, so that security-protected packet includes the DL data and the MAC-I. In applying an encryption function, the base station 104 can encrypt the data to generate an encrypted packet, so that the security-protected packet includes encrypted data. Further, when both integrity protection and encryption are applied, the base station 104 can generate a MAC-I for protecting integrity of the data and encrypt the data along with the MAC-I to generate an encrypted packet and an encrypted MAC-I.

In some implementations, the base station 104 generates a first DL PDU (e.g., a DL PDCP PDU) using the security-protected packet, includes the first DL PDU in a second DL PDU (e.g., a DL MAC PDU associated with the MAC layer), and transmits the second DL PDU to the UE 102 without causing the UE 102 to transition to the RRC_CONNECTED state. In some implementations, the base station 104 includes the DL PDCP PDU in a DL RLC PDU, and further includes the DL RLC PDU in the DL MAC PDU.

In another implementation, the base station 104 transmits the first DL PDU to the base station 106, which then generates a second DL PDU (e.g., a DL MAC PDU) that includes the first DL PDU and transmits the second DL PDU to the UE 102 without causing the UE 102 to transition to the RRC_CONNECTED state. In some implementations, the base station 106 generates a DL RLC PDU that includes the first DL PDU and includes the DL RLC PDU in the second DL PDU. In yet another implementation, the base station 104 includes the first DL PDU in a DL RLC PDU and transmits the DL RLC PDU to the base station 106, which in turn generates a second DL PDU (e.g., a DL MAC PDU) that includes the DL RLC PDU and transmits the second DL PDU to the UE 102.

In some implementations, the base station 104 or 106 generates a downlink control information (DCI) and a cyclic redundancy check (CRC) scrambled with an ID of the UE 102 to transmit the second DL PDU generated by the base station 104 or 106. In some implementations, the ID of the UE 102 can be a Radio Network Temporary Identifier (RNTI), such as a cell RNTI (C-RNTI), a temporary C-RNTI, or an inactive C-RNTI. The base station 104 or 106 can transmit the DCI and scrambled CRC on a physical downlink control channel (PDCCH) to the UE 102 operating in the RRC_INACTIVE or RRC_IDLE state. In some implementations, the base station 104 or 106 may assign the ID of the UE 102 to the UE 102 in a random access response that the base station 104 or 106 transmits in a random access procedure with the UE 102 before transmitting the DCI and scrambled CRC. In other implementations, the base station 104 or 106 may assign the ID of the UE 102 to the UE 102 in an RRC message (e.g., RRC release message or an RRC reconfiguration message) that the base station 104 or 106 transmits to the UE 102 before transmitting the DCI and scrambled CRC.

After receiving the DCI and scrambled CRC on the PDCCH, the UE 102 can confirm that a physical downlink shared channel (PDSCH), including the second DL PDU, is addressed to the UE 102 according to the ID of the UE 102, the DCI, and the scrambled CRC. The UE 102 then can retrieve the data from the security-protected packet. If the security-protected packet is an encrypted packet, the UE 102 can decrypt the encrypted packet using the appropriate decryption function and the security key to obtain the data. If the security-protected packet is the integrity-protected packet (i.e., that includes the data and the MAC-I), the UE 102 can determine whether the MAC-I is valid. If the UE 102 confirms that the MAC-I is valid, the UE 102 retrieves the data; otherwise, the UE 102 discards the data. If the security-protected packet is both encrypted and integrity-protected (i.e., includes encrypted data and an encrypted MAC-I), the UE 102 can decrypt both the encrypted packet and encrypted MAC-I to obtain the data and the MAC-I. The UE 102 then can verify whether the MAC-I is valid for the data. If the UE 102 confirms that the MAC-I is valid, the UE 102 retrieves and processes the data; otherwise, the UE 102 discards the data.

The base station 104 is equipped with processing hardware 130 that can include one or more general-purpose processors (e.g., CPUs) and a non-transitory computer-readable memory storing instructions that the one or more general-purpose processors execute. Additionally or alternatively, the processing hardware 130 can include special-purpose processing units. The processing hardware 130 in an example implementation includes a MAC controller 132 configured to perform a random access procedure with one or more user devices (e.g., UE 102), receive UL MAC PDUs from the one or more user devices, and transmit DL MAC PDUs to the one or more user devices. The processing hardware 130 can also include a PDCP controller 134 configured to transmit and/or receive PDCP PDUs in accordance with the manner in which the base station 104 can transmit DL data and/or receive UL data, respectively. The processing hardware 130 can further include an RRC controller 136 to implement procedures and messaging at the RRC sublayer of the protocol communication stack. The processing hardware 130 in an example implementation includes an RRC inactive controller 138 configured to manage UL and/or DL communications when the one or more UEs operate in the RRC_INACTIVE or RRC_IDLE state. The base station 106 can include processing hardware 140 that is similar to processing hardware 130. In particular, components 142, 144, 146, and 148 can be similar to the components 132, 134, 136, and 138, respectively.

The UE 102 is equipped with processing hardware 150 that can include one or more general-purpose processors such as CPUs and non-transitory computer-readable memory storing machine-readable instructions executable on the one or more general-purpose processors, and/or special-purpose processing units. The processing hardware 150 in an example implementation includes an RRC inactive controller 158 configured to manage UL and/or DL communications when the UE 102 operates in the RRC_INACTIVE or RRC_IDLE state. The processing hardware 150 in an example implementation includes a MAC controller 152 configured to perform a random access procedure with base station 104 or 106, transmit UL MAC PDUs to the base station 104 or 106, and receive DL MAC PDUs from the base station 104 or 106. The processing hardware 150 can also include a PDCP controller 154 configured to transmit and/or receive PDCP PDUs in accordance with the manner in which the UE 102 can transmit UL data and/or receive DL data. The processing hardware 150 can further include an RRC controller 156 to implement procedures and messaging at the RRC sublayer of the protocol communication stack.

FIG. 1B depicts an example distributed or disaggregated implementation of one or both of the base stations 104, 106. In this implementation, each of the base station 104 and/or 106 includes a central unit (CU) 172 and one or more distributed units (DUs) 174. The CU 172 includes processing hardware, such as one or more general-purpose processors (e.g., CPUs) and a computer-readable memory storing machine-readable instructions executable on the general-purpose processor(s), and/or special-purpose processing units. For example, the CU 172 can include a PDCP controller (e.g., PDCP controller 134, 144), an RRC controller (e.g., RRC controller 136, 146), and/or an RRC inactive controller (e.g., RRC inactive controller 138, 148). In some implementations, the CU 172 can include an RLC controller configured to manage or control one or more RLC operations or procedures. In other implementations, the CU 172 does not include an RLC controller.

Each of the DUs 174 also includes processing hardware that can include one or more general-purpose processors (e.g., CPUs) and computer-readable memory storing machine-readable instructions executable on the one or more general-purpose processors, and/or special-purpose processing units. For example, the processing hardware can include a MAC controller (e.g., MAC controller 132, 142) configured to manage or control one or more MAC operations or procedures (e.g., a random access procedure), and/or an RLC controller configured to manage or control one or more RLC operations or procedures. The processing hardware can also include a physical layer controller configured to manage or control one or more physical layer operations or procedures.

In some implementations, the RAN 105 supports Integrated Access and Backhaul (IAB) functionality. In some implementations, the DU 174 operates as an (IAB)-node, and the CU 172 operates as an IAB-donor.

In some implementations, the CU 172 can include a logical node CU-CP 172A that hosts the control plane part of the PDCP protocol of the CU 172. The CU 172 can also include logical node(s) CU-UP 172B that hosts the user plane part of the PDCP protocol and/or SDAP protocol of the CU 172. The CU-CP 172A can transmit control information (e.g., RRC messages, F1 application protocol messages), and the CU-UP 172B can transmit data packets (e.g., SDAP PDUs or IP packets).

The CU-CP 172A can be connected to multiple CU-UPs 172B through the E1interface. The CU-CP 172A selects the appropriate CU-UP 172B for the requested services for the UE 102. In some implementations, a single CU-UP 172B can be connected to multiple CU-CPs 172A through the El interface. If the CU-CP 172A and DU(s) 174 belong to a gNB, the CU-CP 172A can be connected to one or more DU 174s through an F1-C interface and/or an F1-U interface. If the CU-CP 172A and DU(s) 174 belong to an ng-eNB, the CU-CP 172A can be connected to DU(s) 174 through a W1-C interface and/or a W1-U interface. In some implementations, one DU 174 can be connected to multiple CU-UPs 172B under the control of the same CU-CP 172A. In such implementations, the connectivity between a CU-UP 172B and a DU 174 is established by the CU-CP 172A using Bearer Context Management functions.

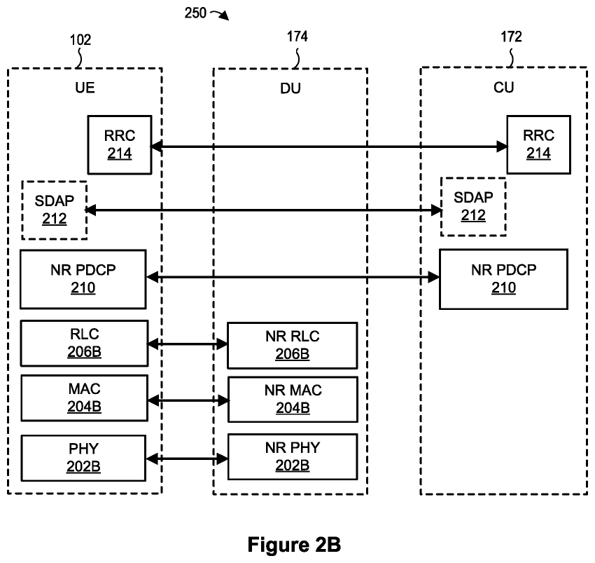

FIG. 2A illustrates, in a simplified manner, an example protocol stack 200 according to which the UE 102 can communicate with an eNB/ng-eNB or a gNB (e.g., one or both of the base stations 104, 106).

In the example stack 200, a physical layer (PHY) 202A of EUTRA provides transport channels to the EUTRA MAC sublayer 204A, which in turn provides logical channels to the EUTRA RLC sublayer 206A. The EUTRA RLC sublayer 206A in turn provides RLC channels to a EUTRA PDCP sublayer 208 and, in some cases, to an NR PDCP sublayer 210. Similarly, the NR PHY 202B provides transport channels to the NR MAC sublayer 204B, which in turn provides logical channels to the NR RLC sublayer 206B. The NR RLC sublayer 206B in turn provides data transfer services to the NR PDCP sublayer 210. The NR PDCP sublayer 210 in turn can provide data transfer services to the SDAP sublayer 212 or an RRC sublayer (not shown in FIG. 2A). The UE 102, in some implementations, supports both the EUTRA and the NR stack as shown in FIG. 2A, to support handover between EUTRA and NR base stations and/or to support dual connectivity (DC) over EUTRA and NR interfaces. Further, as illustrated in FIG. 2A, the UE 102 can support layering of NR PDCP 210 over EUTRA RLC 206A, and SDAP sublayer 212 over the NR PDCP sublayer 210.

The EUTRA PDCP sublayer 208 and the NR PDCP sublayer 210 receive packets (e.g., from an IP layer, layered directly or indirectly over the PDCP layer 208 or 210) that can be referred to as SDUs, and output packets (e.g., to the RLC layer 206A or 206B) that can be referred to as PDUs. Except where the difference between SDUs and PDUs is relevant, this disclosure for simplicity refers to both SDUs and PDUs as “packets.”

On a control plane, the EUTRA PDCP sublayer 208 and the NR PDCP sublayer 210 can provide signaling radio bearers (SRBs) to the RRC sublayer (not shown in FIG. 2A) to exchange RRC messages or NAS messages, for example. On a user plane, the EUTRA PDCP sublayer 208 and the NR PDCP sublayer 210 can provide data radio bearers (DRBs) to support data exchange. Data exchanged on the NR PDCP sublayer 210 can be SDAP PDUS, IP packets, or Ethernet packets.

Thus, it is possible to functionally split the radio protocol stack, as shown by the radio protocol stack 250 in FIG. 2B. The CU at one or both of the base stations 104, 106 can hold all the control and upper layer functionalities (e.g., RRC 214, SDAP 212, NR PDCP 210), while the lower layer operations (e.g., NR RLC 206B, NR MAC 204B, and NR PHY 202B) are delegated to the DU. To support connection to a 5GC, NR PDCP 210 provides SRBs to RRC 214, and NR PDCP 210 provides DRBs to SDAP 212 and SRBs to RRC 214.

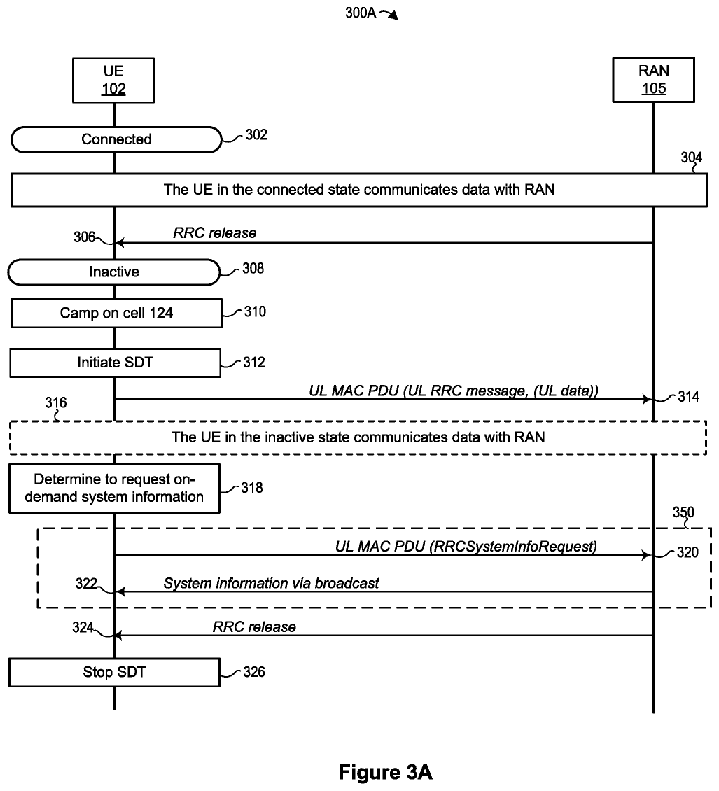

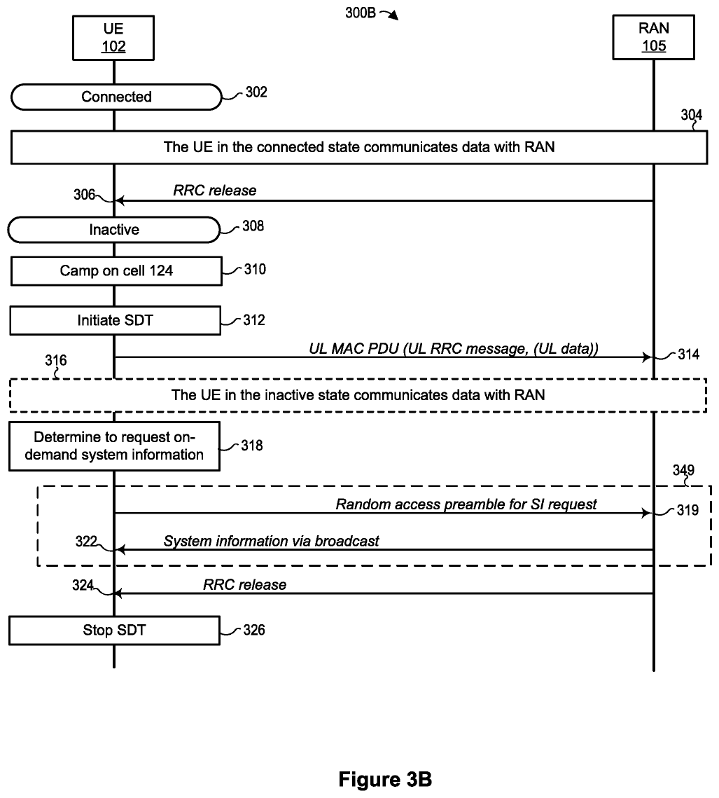

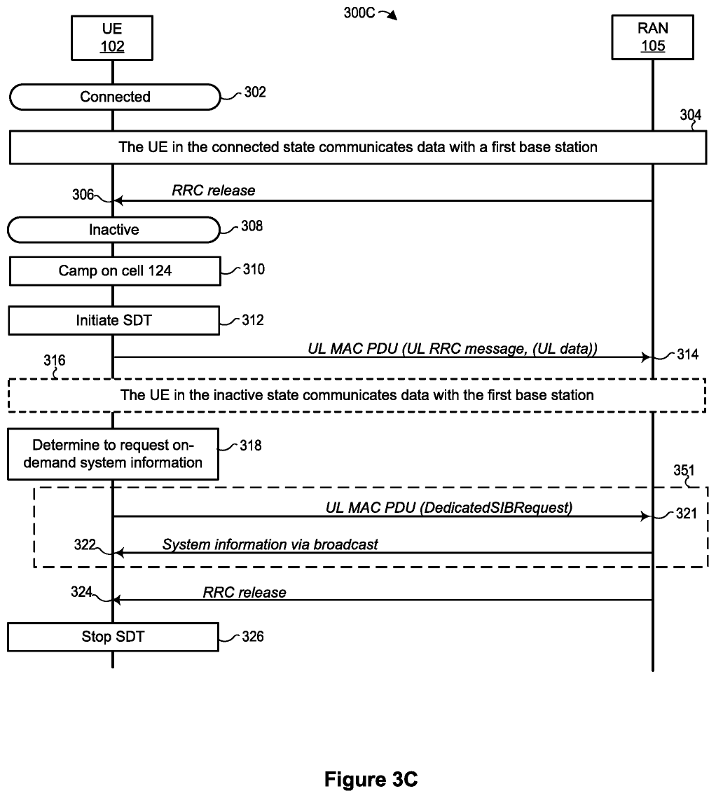

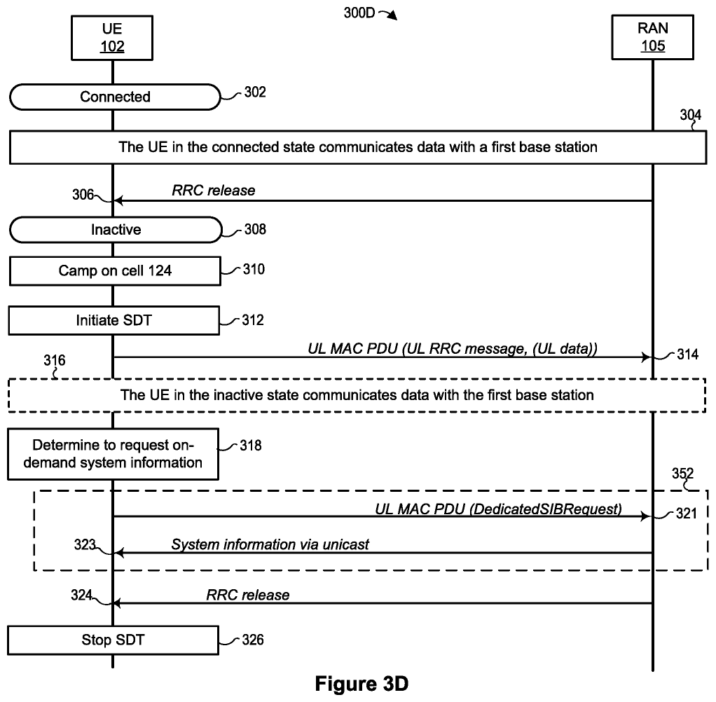

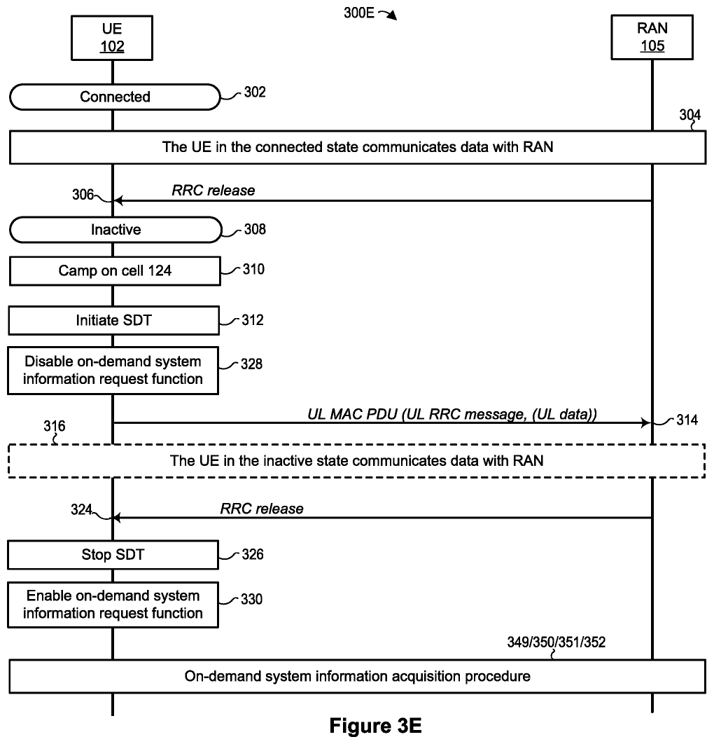

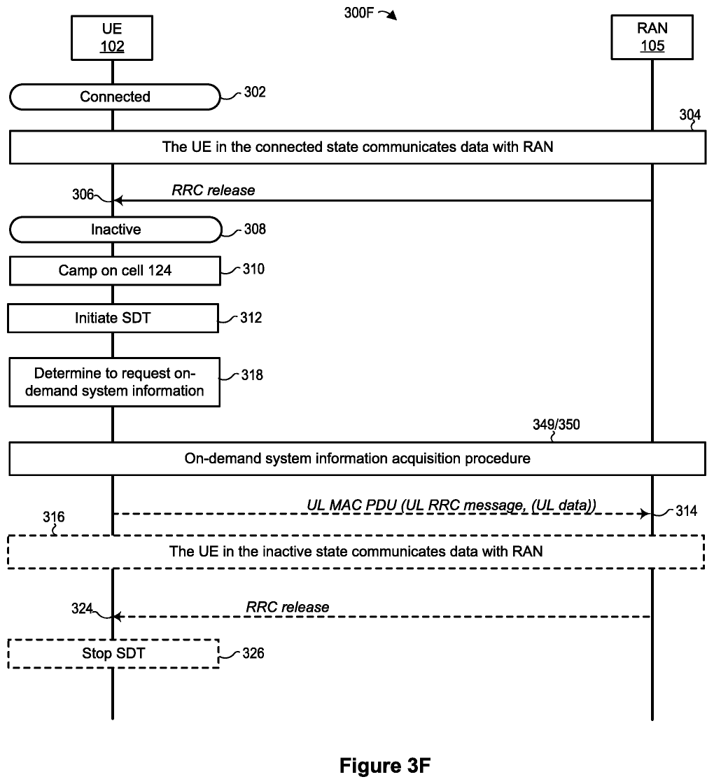

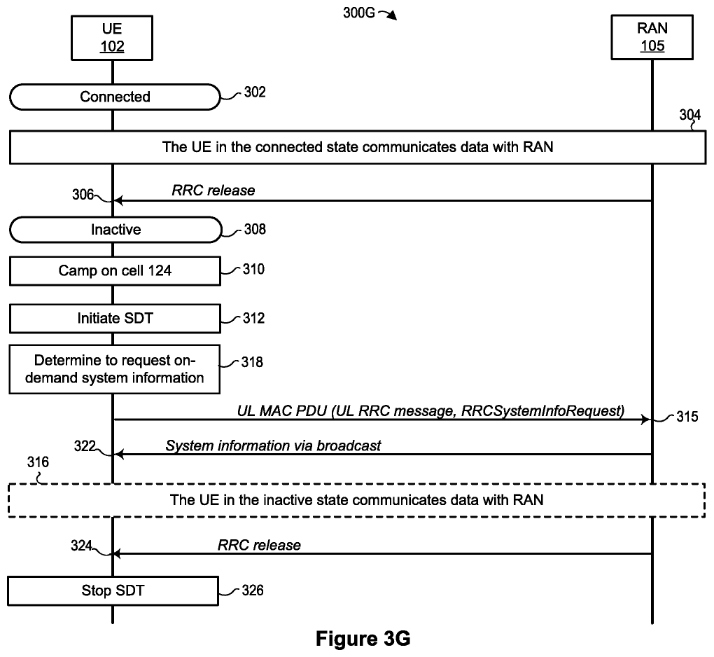

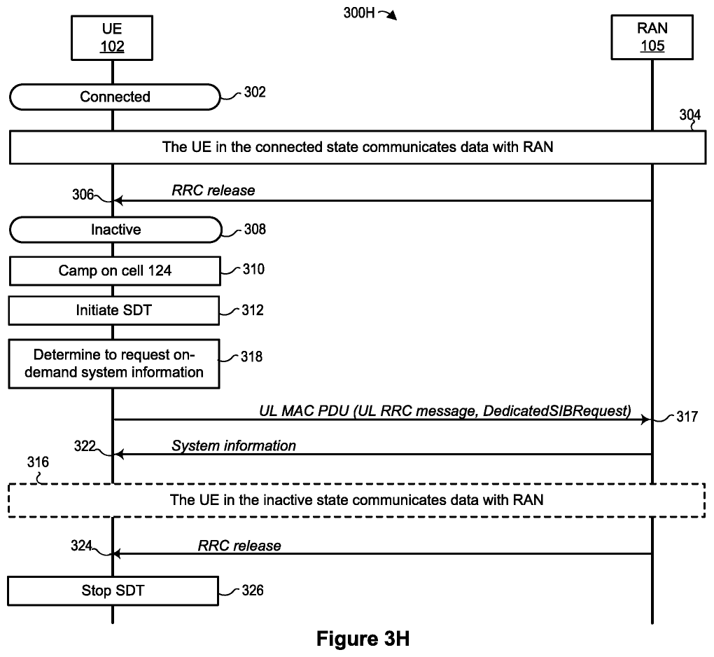

Next, several example scenarios that involve various components of FIG. 1A and relate to managing system information acquisition and transmission while the UE 102 is in an inactive or idle state with SDT are discussed with reference to FIGS. 3A-3H. Generally speaking, events in FIGS. 3A-3H that are the same are labeled with the same reference numbers. To simplify the following description, the “inactive state” is used to represent either the inactive (e.g., RRC_INACTIVE) or idle (e.g., RRC_IDLE) state, unless otherwise noted.

Referring first to FIG. 3A, in a scenario 300A, the UE 102 initially operates 302 in a connected (e.g., RRC_CONNECTED) state and communicates 304 data with the RAN 105 (e.g., base station 104 and/or base station 106), e.g., via one or more radio bearers (RBs). In some implementations, the UE 102 in the connected state communicates 304 control-plane (CP) data with the RAN 105 via one or more signaling RBs (SRBs). In such implementations, the CP data includes RRC PDUs that includes RRC messages, NAS messages, IP packets, Ethernet packets, and/or application packets. In other implementations, the UE 102 in the connected state communicates 304 CP data and/or user-plane (UP) data with the RAN 105 via one or more data RBs (DRBs). The UP data in some example scenarios includes IP packets, Ethernet packets, and/or application packets.

While the UE 102 operates 302 in the connected state, the RAN 105 transmits to the UE 102 a plurality of configuration parameters for communicating with the UE 102 at event 304. The UE 102 communicates 304 with the RAN 105 using the configuration parameters. In some implementations, the configuration parameters include configuration parameters in a CellGroupConfig IE defined in 3GPP specification 38.331. While the UE 102 operates 302 in the connected state, the RAN 105 can transmit to the UE 102 one or more measurement configurations (e.g., MeasConfig IE). The measurement configuration(s) configures one or carrier frequencies and include reporting configuration(s). The UE 102 in the connected state performs measurements on the one or more carrier frequencies and obtains measurement result(s) from the measurements. In some implementations, the measurement result(s) can include, or indicate reference signal received quality (RSRP), reference signal received quality (RSRQ), and/or signal to interference and noise ratio (SINR) value(s) for the one or more carrier frequencies or for one or more cells operated on the one or more carrier frequencies. In some implementations, the RAN 105 can include measurement gap configuration(s) in the measurement configuration(s) so that the UE 102 can measure a particular carrier frequency using gap(s) configured in the measurement gap configuration(s). If the UE 102 detects that a reporting condition in the reporting configuration(s) is met, the UE 102 can transmit a measurement report including the measurement result(s) to the RAN 105.

After a (first) certain period of data inactivity, the RAN 105 can determine that neither the RAN 105 nor the UE 102 has transmitted any data in the downlink direction or the uplink direction, respectively, during the certain period. In response to the determination, the RAN 105 can transmit 306 a first DL RRC message to the UE 102 to instruct the UE 102 to transition 308 to the inactive state. In some implementations, the first DL RRC message can be a first RRC release message (e.g., RRCRelease message or RRCConnectionRelease message). In some implementations, the RAN 105 can assign an I-RNTI or a resume ID to the UE 102 and include the assigned value in the first RRC release message. In addition, the RAN 105 can include a security configuration (e.g., NextHopChainCount IE) in the first RRC release message. The UE 102 applies the security configuration to obtain one or more security keys (e.g., encryption key and/or integrity key). The UE 102 uses the security key(s) to perform one or more security functions with respect to UL data and/or DL data in an SDT session (e.g., data exchanged between event 314 and 324, such as events 314, 316, 320, 322, 324, and/or other data exchanged during events not shown in FIG. 3A).

In some implementations, the RAN 105 includes an SDT configuration in the first RRC release message to enable SDT for the UE 102 (i.e., to enable the UE 102 to perform SDT upon receiving the first RRC release message). The RAN 105 in some implementations can indicate RBs as SDT RB(s) (i.e., the RB(s) are suitable or configured for SDT) or non-SDT RB(s) (i.e., the RB(s) are unsuitable or not configured for SDT). For example, the RAN 105 can include at event 306 an SDT indication in the first RRC release message to indicate that a first SRB is an SDT RB. In cases where the RAN 105 does not include an SDT indication for a second SRB in the first RRC release message, the UE 102 determines that the second SRB is a non-SDT RB by default. Alternatively, the RAN 105 can include a non-SDT indication in the first RRC release message to indicate that the second SRB is a non-SDT RB. In another similar example, the RAN 105 can include an SDT indication in the first RRC release message to indicate that a first DRB is an SDT RB. In cases that the RAN 105 does not include an SDT indication for a second DRB in the first RRC release message, the UE 102 determines that the second DRB is a non-SDT DRB by default. Alternatively, the RAN 105 can include a non-SDT indication in the first RRC release message to indicate that the second DRB is a non-SDT RB. In other implementations, particular RB(s) (e.g., SRB0,SRB1, and/or SRB2) can be considered SDT RB(s) by default, even though the RAN 105 does not indicate that the particular RB(s) are SDT RB(s) in the first RRC release message. In such implementations, the UE 102 determines that the particular RB(s) are SDT RB(s) as a default, even though the UE 102 does not receive from the RAN 105 indication(s) that identify the particular RB(s) as SDT RB(s).

The SDT configuration can include one or more SDT initiation criteria configurations, a configured grant (CG) configuration, multiple CG configurations, a configuration of HARQ retransmission with the CG configuration(s), a subsequent SDT configuration, a repetition configuration, a PDCCH configuration, a PUCCH configuration, and/or PUSCH configuration. The SDT configuration can also include a UL bandwidth part (BWP) configuration and/or a DL BWP configuration. Some of the configurations described above in the SDT configuration can be CG-SDT specific configurations, RA-SDT specific configurations or common configurations for both CG-SDT and RA-SDT.

For example, the SDT initiation criteria configuration(s) can include a signal strength threshold (e.g., RSRP threshold, RSRQ threshold, SINR threshold, and/or other suitable metrics), a maximum data volume size, a maximum packet size, and/or a maximum number of packets for an SDT session. In accordance with the SDT initiation criteria configuration(s), in some implementations, the UE 102 can perform SDT (i.e., initial SDT and/or subsequent SDT) only if a signal strength obtained by the UE 102 from measurements is above the signal strength threshold specified by the SDT initiation criteria configuration(s). In some implementations, the maximum data volume size specifies a maximum number of octets for all SDT RB(s) (i.e., the RB(s) suitable or configured for SDT) that the UE 102 can transmit in an SDT session. In some implementations, the maximum packet size specifies a maximum number of octets that the UE 102 can transmit in a single SDT (i.e., an uplink MAC PDU). In other implementations, the maximum packet size specifies a maximum number of octets for a single packet that the UE 102 can transmit. The single packet can be an application data packet (e.g., IP packet or Ethernet packet), an SDAP PDU, a NAS PDU, an RRC PDU, a PDCP SDU, a PDCP PDU, or an RLC PDU.

As another example, each, or at least some, of the CG configurations(s) can include a time domain resources allocation configuration, a frequency domain resources allocation configuration, a hybrid automatic repeat request (HARQ) configuration, one or more SDT initiation criteria configurations, a repetition configuration, a PDCCH configuration, a PUCCH configuration, a PUSCH configuration, a configuration of HARQ retransmission, a frequency hopping configuration, and/or a physical layer acknowledgement configuration, which are specific for SDT using radio resources configured by the CG configuration(s). In other implementations, each, or at least some, of the CG configuration(s) can include configuration parameters similar to configuration parameters included in a ConfiguredGrantConfiguration IE specified in 3GPP specification 38.331.

In some implementations, the subsequent SDT configuration can configure the number of subsequent data packets, the number of bytes for subsequent data or the number of CG radio resources that the UE 102 is allowed to use or transmit for subsequent UL data in an SDT session. In some implementations, where the RAN 105 does not provide the UE 102 with the subsequent SDT configuration, the UE 102 is consequently disabled from transmitting subsequent UL data in an SDT session. Alternatively, the UE 102 is allowed to transmit subsequent UL data without any restriction, in cases where the RAN 105 does not provide the UE 102 with the subsequent SDT configuration. In some implementations, the repetition configuration enables or configures the UE 102 to transmit repetitions of a UL transmission (e.g., a PUSCH transmission or a UL MAC PDU) in an SDT session. In cases where the RAN 105 does not provide the UE 102 with the repetition configuration, the UE 102 is consequently disabled from transmitting repetitions for a UL transmission in an SDT session.

In response to or upon receiving the first RRC release message at event 306, the UE 102 transitions 308 to the inactive state and retains a portion or all of the configuration parameters that the UE 102 applied to communicate with the RAN 105 while operating in the connected state. The UE 102 also retains the measurement configuration(s) upon transitioning to the inactive state. In some implementations in which either the base station 104 or base station 106 of the RAN 105 is a distributed or disaggregated base station including a CU 172 and DU 174 as described in FIG. 1B, after the UE 102 transitions 308 to the inactive state, the UE 102 can perform one or more RAN notification area (RNA) updates with the CU 172 via the DU 174 without state transitions (e.g., without transitioning from the inactive state back to the connected state).

After the UE 102 transitions 308 to the inactive state, the UE 102 camps 310 (e.g., selects or reselects) on cell 124. At a later time, the UE 102 in the inactive state initiates 312 SDT (e.g., in accordance with the SDT configuration received in event 306) to transmit UL data or receive DL data. In cases of transmitting, e.g., at event 314, UL data while the UE 102 is in the inactive state, the SDT is referred to as mobile originating (MO) SDT. In cases of receiving DL data while the UE 102 is in the inactive state, the SDT is referred to as mobile terminating (MT) SDT (i.e., small data reception from the viewpoint of the UE 102). In such cases, the UE 102 at event 312 receives from the RAN 105 a paging message, which includes a UE ID of the UE 102 and an SDT indication. The UE ID can be an I-RNTI, a resume ID, or a NAS ID (e.g., S-TMSI or 5G-S-TMSI). In response to the paging message (i.e., the UE ID and the SDT indication), the UE 102 initiates SDT.

In some implementations, the UE 102 can initiate SDT only if a signal strength obtained by the UE 102 from measuring a serving carrier frequency of the cell 124 exceeds a signal strength threshold specified by the SDT initiation criteria configuration(s). If the signal strength exceeds the signal strength threshold, the UE 102 can begin performing SDT via the cell 124.

In some implementations, the UE 102 can determine whether the UL data for transmission during SDT qualifies for transmission in the inactive state in view of one or more factors, such as whether the UL data is an IMS packet, whether the UL data is associated with a radio bearer (e.g., DRB or SRB) not suitable or configured for SDT, whether the UL data is an NAS message for initiating a particular NAS procedure, the size of the data, and/or one or more other factors. If the UE 102 determines that the UL data does not qualify for transmission in the inactive state, the UE 102 can perform an RRC procedure (e.g., RRC connection establishment procedure or RRC resume procedure) to transition to the connected state.

After or in response to initiating 312 the SDT, the UE 102 transmits 314 an initial UL MAC PDU to RAN 105 on the cell 124. In cases of MO SDT, the UE 102 can include UL data in the initial UL MAC PDU, and the RAN 105 retrieves the UL data from the initial UL MAC PDU. In cases of MT SDT, the UE 102 does not include UL data in the initial UL MAC PDU. The UL RRC message can be a CCCH message, an RRC resume request message, or an RRC early data request message, as described above in reference to FIG. 1A. For MO SDT, the UL RRC message can include a cause value (e.g., “mo-data”), which can be a field or information element (IE) (e.g., resumeCause or ResumeCause). For MT SDT, the UL RRC message can include an SDT indication which can be a field or IE (e.g., resumeCause or ResumeCause).

In some implementations, to transmit the initial UL MAC PDU at event 314, the UE 102 in the inactive state performs a random access procedure with the RAN 105 on the cell 124. For example, the random access procedure can be a four-step random access procedure or a two-step random access procedure. In the case of the four-step random access procedure, the UE 102 transmits a random access preamble to the RAN 105, the RAN 105 in response transmits to the UE 102 a random access response (RAR) including an uplink grant, and the UE 102 transmits 314 the UL MAC PDU as a message 3 of the four-step random access procedure in accordance with the uplink grant. The RAN 105 receives 314 the UL MAC PDU in accordance with the uplink grant in the RAR. In the case of the two-step random access procedure, the UE 102 transmits 314 to the RAN 105 a message A including a random access preamble and the UL MAC PDU in accordance with two-step random access configuration parameters. The UE 102 can receive the two-step random access configuration parameters in system information broadcast by the RAN 105 on cell 124 before transmitting 314 the UL MAC PDU. The RAN 105 receives 314 the UL MAC PDU in accordance with the two-step random access configuration parameters. In further implementations, the UE 102 can transmit 314 the UL MAC PDU on radio resources configured in CG configuration(s). The RAN 105 can include the CG configuration to the UE 102 in the first RRC release message, as described above. Thus, the RAN 105 receives 314 the UL MAC PDU on the radio resources.

After receiving 314 the UL RRC message and/or the UL data, the RAN 105 refrains from transitioning the UE 102 to a connected state and communicates 316 data (i.e., UL data and/or DL data) with the UE 102 operating in the inactive state. In some implementations, the data at event 314 or 316 can include at least one data packet for an application or a protocol layer, such as an MM layer (e.g., 5G MM), an SM layer (e.g., 5G SM), an LTE positioning protocol (LPP) layer, or a secure user-plane location (SUPL) protocol layer. The data packet can be an IP packet, an Ethernet packet, an application packet. In other implementations, the data packet can be a PDCP PDU that includes an RRC PDU, an MM PDU, an SM PDU, an LPP PDU, an IP packet, an Ethernet packet, or an application packet. In yet other implementations, the data packet can be an RRC PDU including a NAS PDU, such that the NAD PDU includes an IP packet, an Ethernet packet, or an application packet. More specifically, the UE 102 can transmit 316 to the RAN 105 one or more UL MAC PDUs, and/or the RAN 105 can transmit 316 to the UE 102 one or more DL MAC PDUs, where each of the UL MAC PDU(s) and/or DL MAC PDU(s) can include a particular data packet or a particular segment of a data packet. In some implementations, the UE 102 can transmit 316, each or at least some, of the UL MAC PDU(s) on radio resources configured in the CG configuration(s) described above. In other implementations, the RAN 105 can transmit to the UE 102 one or more DCIs for the UE 102 on PDCCH(s) where each of the DCI(s) includes an uplink grant. In such cases, the UE 102 transmits 316 each, or at least some, of the UL MAC PDU(s) on radio resources assigned by the uplink grant(s). Similarly, the RAN 105 can transmit one or more DCIs for the UE 102 on PDCCH(s), where each of the DCI(s) includes a downlink assignment. In such cases, the UE 102 receives 316 the DL MAC PDU(s) on radio resources assigned by the downlink assignment(s).

In some implementations, the RAN 105 can transmit the DCI(s) on the PDCCH(s) via the cell 124 using a search space for SDT (i.e., SDT-specific search space). The RAN 105 can include an SDT-specific search space configuration specifying/configuring the SDT-specific search space in the first DL RRC message. Alternatively, the RAN 105 can broadcast a SIB including the SDT-specific search space configuration via the cell 124 and/or other cell(s) (e.g., cell 125 and/or cell 126). In such cases, the UE 102 can use the SDT-specific search space to receive the DCI(s) on the PDCCH(s) via the cell 124. In cases where the RAN 105 does not provide an SDT-specific search space configuration to the UE 102, the RAN 105 can transmit the DCI(s) on the PDCCH(s) using a common search space. In such cases, the UE 102 can use the common search space to receive the DCI(s) on the PDCCH(s) via the cell 124. The RAN 105 can broadcast, via the cell 124, a SIB including a common search space configuration specifying/configuring the common search space.

Generally, when the RAN 105 receives all segments of a data packet from the UE 102, the RAN 105 assembles the segments to obtain the data packet and can process the data packet or send the data packet to the CN 110. In some implementations, the UE 102 at event 316 can transmit a plurality of segments of a particular data packet for an application or a protocol layer to the RAN 105, until all segments of the data packet are transmitted to the RAN 105. Similarly, when the UE 102 receives 316 all segments of a data packet from the RAN 105, the UE 102 assembles the segments to obtain the data packet.

During the SDT session of event 316, the UE 102 determines 318 to request on-demand system information. In response to the determination, the UE 102 generates an RRC system information (SI) request message (e.g., a RRCSystemInfoRequest message) and transmits 320 a UL MAC PDU including the RRC SI request message (e.g., including a RRCSystemInfoRequest message) to the RAN 105. More specifically, the UE 102 transmits the RRC SI request message on a CCCH to the RAN 105. In the RRC SI request message, the UE 102 can include SI request information indicating which SI message(s) that the UE 102 is requesting, so that the RAN 105 can determine which SI message(s) that the UE 102 is requesting from the SI request information. For example, the SI request information can indicate SI message(s) for non-positioning SI and/or SI message(s) for positioning.

In some implementations, the UE 102 can perform a random access procedure (e.g., a four-step or two-step random access procedure) with the RAN 105 to transmit the RRC SI request message, and transmits 320 the UL MAC PDU in a message 3 of the four-step random access procedure or in a message A of the two-step random access procedure, similar to the event 314. In such cases, the UE 102 refrains from transmitting the UL MAC PDU including the RRC SI request message on radio resources configured in the CG configuration. If the UE 102 receives a DCI, for the UE 102 on a PDCCH, that includes an uplink grant (e.g., for a new transmission), as described above for the event 316, the UE 102 refrains from transmitting the UL MAC PDU including the RRC SI request message using the uplink grant.

In one implementation, the UE 102 refrains from including both the RRC SI request message and UL data (described above) in the same UL MAC PDU. Such an implementation prevents the UL data from preempting the RRC SI request message in the UL MAC PDU 320. Such an implementations also prevents the RRC SI request message from occupying payload space of a UL MAC PDU for UL data, so that the UE 102 can fully utilize the payload space of a UL MAC PDU for UL data.

In some implementations, the UE 102 can transmit 320 the UL MAC PDU including the RRC SI request message on radio resources configured in the CG configuration, or using an uplink grant (e.g., for a new transmission) configured in a DCI that the UE 102 receives from the RAN 105. In such implementations, the UE 102 can refrain from performing a random access procedure with the RAN 105 to transmit the RRC SI request message. By skipping a random access procedure, the UE 102 can quickly transmit the RRC SI request message to the RAN 105.

In response to or after receiving 320 the RRC SI request message from the UE 102, the RAN 105 can transmit 322 the requested SI message(s) via broadcast. Thus, the UE 102 receives 322 the requested SI message(s) broadcast by the RAN 105 during the SDT session. The events 320 and 322 of FIG. 3A are collectively referred to as an on-demand SI acquisition procedure 350.

In some implementations, the on-demand SI acquisition procedure 350 can occur during or after the event 316. In other implementations, the UE 102 in the inactive state can transmit UL data to the RAN 105, and/or receive DL data from the RAN 105, after receiving 322 the requested SI message(s). In cases where the requested SI message(s) are positioning SI message(s) or include positioning SIB(s), the UE 102 can communicate the UL data and/or DL data with the RAN 105 for a location service. In this example, the UL data and/or DL data can be or include LPP messages.

After a (second) certain period of data inactivity for the UE 102, the RAN 105 can determine that neither the RAN 105 nor the UE 102 has transmitted any data in the downlink direction or the uplink direction after events 314 and/or 316, respectively, during the (second) certain period. In response to the determination, the RAN 105 can transmit 324 a second DL RRC message (e.g., a second RRC release message) to the UE 102, similar to event 306. In some implementations, the UE 102 can receive a DCI configuring a downlink assignment on a PDCCH from the RAN 105, and receive 324 the second DL RRC message on radio resources configured in the downlink assignment. In some implementations, the UE 102 can receive the DCI on the PDCCH via the cell 124 using the SDT-specific search space configuration. In cases where the UE 102 does not receive an SDT-specific search space configuration from the RAN 105, the UE 102 can receive the DCI on the PDCCH via the cell 124 using the common search space configuration.

In response to the second DL RRC message, the UE 102 remains in the inactive state and stops 326 SDT (i.e., the SDT session ends). In some implementations, the RAN 105 can assign an I-RNTI or a resume ID to the UE 102 and include the assigned value in the second RRC release message. In addition, the RAN 105 can include a security configuration (e.g., NextHopChainCount IE) in the second RRC release message. The UE 102 can apply the security configuration to obtain one or more security keys (e.g., encryption key and/or integrity key) and use the security key(s) to perform one or more security functions to UL data and/or DL data communicated with the RAN 105 in the next SDT session. In some implementations, the first and second periods of data inactivity are the same time period. In other implementations, the first and second periods of data inactivity are different.

In some alternative implementations, the second DL RRC message can be an RRC reject message instead of an RRC release message. In such cases, the RAN 105 in one implementation may apply the security function (e.g., integrity protection) to the RRC reject message. Alternatively, the RAN 105 does not apply the security function(s) to the RRC reject message.

In some implementations, the RAN 105 can indicate that the UE 102 is to use the (current) SDT configuration (i.e., received at event 306) in the second DL RRC message. In other implementations, the RAN 105 can include a second SDT configuration in the second DL RRC message to update the current SDT configuration. The second SDT configuration can include one or more configurations similar to the current SDT configuration described above.

In some implementations, the RAN 105 can determine the first and second periods based on the RB(s) with which the UL data and/or DL data at event 304 and event 314 or 316, respectively, are associated. For example, in the case where the UL data and/or DL data at event 304 and event 314 or 316, respectively, are associated with a first RB, the RAN 105 can set the first and second periods to a first time period. In the case where the UL data and/or DL data at event 304 and event 314 or 316, respectively, are associated with a second RB, the RAN 105 can set the first and second periods to a second time period. In the case where the UL data and/or DL data at event 304 and event 314 or 316, respectively, are associated with a third RB, the RAN 105 can set the first, second, and/or third periods to a third time period. In other implementations, the RAN 105 determine the first and second time periods irrespective of any RB(s). For example, the RAN 105 can determine the first and second time periods to be the same time period. In yet other implementations, the RAN 105 can determine the first and second time periods to be different time periods. For example, the RAN 105 can set the first time period to be longer than the second time period.

In the above description, the events 314, 316, 318, 320, 322, and 324 occur between the UE 102 and the RAN 105 via the cell 124.

Turning to FIG. 3B, a scenario 300B is similar to the scenario 300A, except that the UE 102 in scenario 300B transmits 319 to the RAN 105 a random access preamble for an (on-demand) SI request that the UE 102 can use, instead of the RRC SI request message 320, to request that the RAN 105 transmit the SI message(s). The UE 102 transmits the random access preamble on a physical random access channel (PRACH) to the RAN 105 via the cell 124 in response to the determination 318. The RAN 105 can broadcast via the cell 124 a SIB configuring the random access preamble dedicated for (on-demand) SI request. The RAN 105 can then transmit 322 the requested SI message(s) via broadcast in response to detecting or identifying the random access preamble. More generally, the UE 102 may use any sort of dedicated RACH configuration to request system information from the RAN 105 (e.g., a dedicated random access preamble as discussed above, or a dedicated PRACH, etc.) The events 319 and 322 of FIG. 3B are collectively referred to as an on-demand SI acquisition procedure 349. In some implementations, the on-demand SI acquisition procedure 349 can occur during or after the event 316.

Turning to FIG. 3C, a scenario 300C is similar to the scenario 300A, except that the UE 102 in scenario 300C transmits 321 to the RAN 105 an RRC dedicated SI request message (e.g., DedicatedSIBRequest message), instead of the RRC SI request message 320, to request that the RAN 105 transmit the SI message(s). More specifically, the UE 102 transmits the RRC dedicated SI request message to the RAN 105 on a DCCH and via the cell 124. In the RRC dedicated SI request message, the UE 102 can include SI request information indicating the particular SI message(s) that the UE 102 is requesting, to allow the RAN 105 to determine (from the SI request information) which SI message(s) the UE 102 is requesting. For example, the SI request information can indicate SI message(s) for non-positioning SI and/or SI message(s) for positioning.

In some implementations, the UE 102 can transmit 321 a UL MAC PDU including the RRC dedicated SI request message on radio resources configured in the CG configuration, or using an uplink grant (e.g., for a new transmission) configured in a DCI that the UE 102 receives from the RAN 105. In such implementations, the UE 102 can refrain from performing a random access procedure with the RAN 105 to transmit the RRC dedicated SI request message. By skipping a random access procedure, the UE 102 can quickly transmit the RRC dedicated SI request message to the RAN 105.

The events 321 and 322 of FIG. 3C are collectively referred to as an on-demand SI acquisition procedure 351. In some implementations, the on-demand SI acquisition procedure 351 can occur during or after the event 316.

Turning to FIG. 3D, a scenario 300D is similar to the scenarios 300A and 300C, except that the RAN 105 in scenario 300D transmits 323 the requested SI message(s) to the UE 102 via unicast via the cell 124, instead of transmitting 322 the requested SI message(s) via broadcast as in the scenarios 300A and 300C. In some implementations, the RAN 105 can transmit (i.e., unicast) 323 the requested SI message(s) to the UE 102 via a DCCH and the cell 124. In some implementations, the RAN 105 can transmit (i.e., unicast) 323 a dedicated RRC message including the requested SI message(s) to the UE 102 via a DCCH and the cell 124. In some implementations, the dedicated RRC message can be an RRC reconfiguration message (e.g., RRCReconfiguration message). In response to the RRC reconfiguration message, the UE 102 can transmit an RRC reconfiguration complete message (e.g., RRCReconfigurationComplete message) to the RAN 105 via the cell 124 during the SDT session. In other implementations, the dedicated RRC message can be a new RRC message included in a UL-DCCH-Message message. In such implementations, the RAN 105 can transmit (i.e., unicast) 323 the UL-DCCH-Message message to the UE 102 via the DCCH and the cell 124.

The events 321 and 323 in FIG. 3D are collectively referred to as an on-demand SI acquisition procedure 352. In some implementations, the on-demand SI acquisition procedure 352 can occur during or after the event 316. Because the UE 102 and RAN 105 perform the on-demand SI acquisition procedure via the DCCH and unicast, the UE 102 can more quickly receive the requested SI message(s) compared to the on-demand SI acquisition procedures 349, 350, and 351.

Turning to FIG. 3E, a scenario 300E is similar to the scenarios 300A-300D, except that the UE 102 disables (or suspends) 328 an on-demand system information request function of the UE 102 after (e.g., in response to) the initiation 312, and enables (or resumes the suspended) 330 the on-demand system information request function after (e.g., in response to) stopping 326 the SDT session. While the on-demand system information request function is disabled, the UE 102 refrains from transmitting a system information request (e.g., an RRC SI request message, a random access preamble for SI request, or an RRC dedicated SI request message) to the RAN 105.

By disabling 328 the on-demand system information request function in response to the initiation 312, there is no on-demand system information acquisition procedure to interrupt or delay the SDT session. After the UE stops 326 the SDT session, the UE 102 can determine to request on-demand system information and, in response, perform an on-demand system information acquisition procedure with the RAN 105 to obtain SI message(s), similar to the procedure 349, 350, 351, or 352.

Turning to FIG. 3F, a scenario 300F is similar to the scenarios 300A-300D, with differences described below. In the scenario 300F, the UE 102 simultaneously makes the initiation 312 and the determination 318, and prioritizes the determination 318 over the initiation 312. As used herein, the term “simultaneously” may mean “substantially simultaneously.” For example, the initiation 312 and the determination 318 may occur precisely at the same time as part of the same processing step, or may be separated by some number of processor cycles, etc. In response to the prioritization, the UE 102 performs an on-demand system information acquisition procedure with the RAN 105 to obtain SI message(s), similar to the procedure 349 or 350.

Turning to FIG. 3G, a scenario 300G is similar to the scenario 300F, with differences described below. In the scenario 300G, the UE 102 simultaneously makes the initiation 312 and the determination 318. In the case of MO SDT, the UE 102 prioritizes the RRC SI request message over UL data (e.g., the UL data included in the event 314). In response to the determination 318 (in the case of MT SDT) or the prioritization (in the case of MO SDT), the UE 102 transmits 315 an UL MAC PDU including the UL RRC message and the RRC SI request message to the RAN 105. In the case of MO SDT, the UE 102 can transmit the UL data to the RAN 105 during the event 316.

Turning to FIG. 3H, a scenario 300H is similar to the scenario 300G, with differences described below. In the scenario 300G, the UE 102 simultaneously makes the initiation 312 and the determination 318. In the case of MO SDT, the UE 102 prioritizes the RRC dedicated SI request message over UL data (e.g., the UL data included in the event 314). In response to the determination 318 (in the case of MT SDT) or the prioritization (in the case of MO SDT), the UE 102 transmits 317 an UL MAC PDU including the UL RRC message and the RRC dedicated SI request message to the RAN 105. In the case of the MO SDT, the UE 102 can transmit the UL data to the RAN 105 during the event 316.

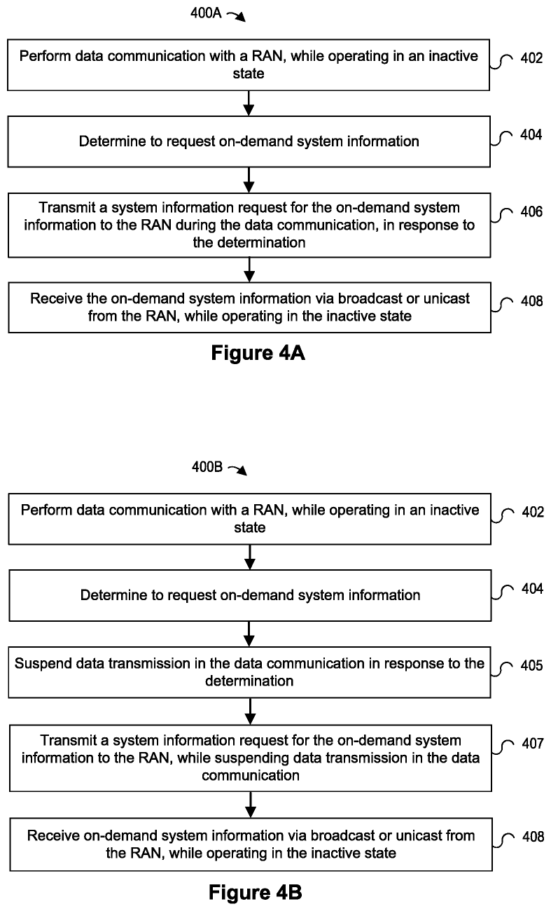

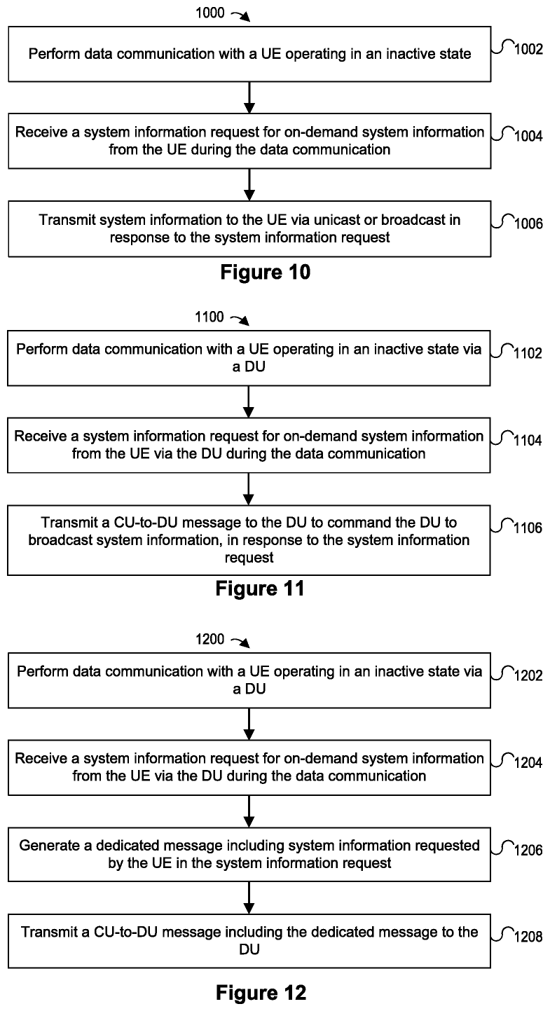

FIGS. 4A-9B are flow diagrams depicting example methods that a UE (e.g., the UE 102) can implement to manage SI acquisition during an SDT session. FIGS. 10-17 are flow diagrams depicting example methods that a RAN (e.g., the RAN 105, base station 104/106, CU 172, CU-CP 172A) can implement to manage transmission of system information to a UE (e.g., the UE 102) during an SDT session.

Turning first to FIG. 4A, a UE (e.g., the UE 102) can implement an example method 400A to transmit a system information request to a RAN (e.g., the RAN 105, base station 104/106, CU 172, CU-CP 172A), while communicating data with the RAN in the inactive state.

The method 400A begins at block 402, where the UE performs data communication (i.e., during an SDT session) with a RAN, while operating in an inactive state (e.g., events 314, 316). At block 404, the UE determines to request on-demand system information (e.g., event 318). At block 406, the UE transmits a system information request for the on-demand system information to the RAN during the data communication, in response to the determination (e.g., events 319, 320, 321, 322, 349, 350, 351, 352). At block 408, the UE receives the on-demand system information via broadcast or unicast from the RAN, while operating in the inactive state (e.g., events 322, 323).

FIG. 4B is a flow diagram of an example method 400B, which is similar to the method 400A except for blocks 405 and 407. At block 405, the UE suspends data transmission in the data communication in response to the determination at block 404. At block 407, the UE transmits a system information request for the on-demand system information to the RAN, while data transmission in the data communication is suspended (e.g., events 315, 317, or events 349 or 350 of FIG. 3F). At block 408, the UE receives the on-demand system information via broadcast or unicast from the RAN, while operating in the inactive state (e.g., events 322, 323). After receiving the on-demand system information, the UE can resume data transmission with the RAN (e.g., event 316).

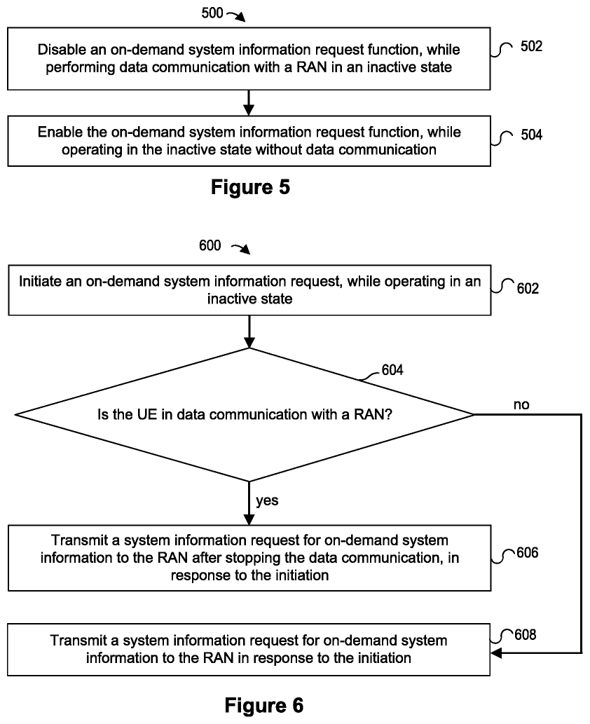

Turning to FIG. 5, a UE (e.g., the UE 102) can implement an example method 500 to disable and enable an on-demand system information request function, while operating in the inactive state.

The method 500 begins at block 502, where the UE disables an on-demand system information request function of the UE while performing data communication with a RAN in an inactive state (e.g., event 328). At block 504, the UE enables the on-demand system information request function while operating in the inactive state without data communication, while operating in the inactive state (e.g., 330).

Turning to FIG. 6, a UE (e.g., the UE 102) can implement an example method 600 to transmit a system information request to a RAN (e.g., the RAN 105, base station 104/106, CU 172, CU-CP 172A), while operating in the inactive state.

The method 600 begins at block 602, where the UE initiates an on-demand system information request, while operating in an inactive state. At block 604, the UE determines whether the UE is in data communication (i.e., an SDT session) with a RAN. If the UE determines the UE is in data communication with a RAN, the flow proceeds to block 606. At block 606, the UE transmits a system information request for on-demand system information to the RAN after stopping the data communication, in response to the initiation (e.g., events 319, 320, 321, 322, 349, 350, 351, 352). Otherwise, if the UE determines the UE is not in data communication with a RAN, the flow proceeds to block 608. At block 608, the UE transmits a system information request for on-demand system information to the RAN in response to the initiation (e.g., events 319, 320, 321, 322, 349, 350, 351, 352).

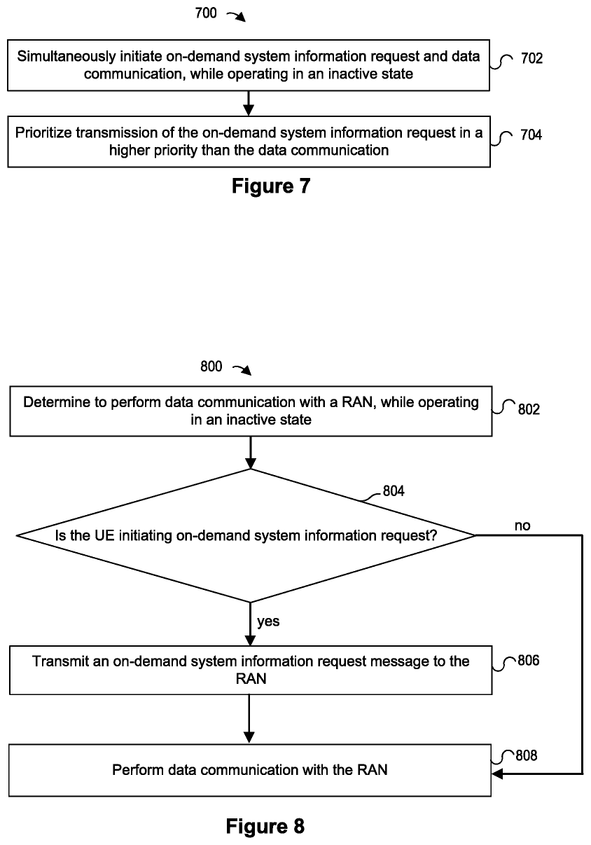

Turning to FIG. 7, a UE (e.g., the UE 102) can implement an example method 700 to transmit a system information request to a RAN (e.g., the RAN 105, base station 104/106, CU 172, CU-CP 172A), while operating in the inactive state.

The method 700 begins at block 702, where the UE simultaneously initiates on-demand system information request and data communication, while operating in an inactive state (e.g., events 312, 318). At block 704, the UE prioritizes transmission of the on-demand system information request in a higher priority than the data communication.

Turning to FIG. 8, a UE (e.g., the UE 102) can implement an example method 800 to transmit a system information request to a RAN (e.g., the RAN 105, base station 104/106, CU 172, CU-CP 172A), while operating in the inactive state.

The method 800 begins at block 802, where the UE determines to perform data communication (i.e., SDT) with a RAN, while operating in the inactive state (e.g., event 312). At block 804, the UE determines whether the UE is initiating an on-demand system information request. If the UE determines the UE is initiating an on-demand system information request, the flow proceeds to block 806. At block 806, the UE transmits an on-demand system information request message (e.g., events 319, 320, 321, 322, 349, 350, 351, 352) and the flow then proceeds to block 808. That is, the UE performs the data communication with the RAN after transmitting the on-demand system information request message. Otherwise, if the UE determines the UE is not initiating an on-demand system information request, the flow proceeds to block 808. At block 808, the UE performs the data communication (e.g., events 314, 316).

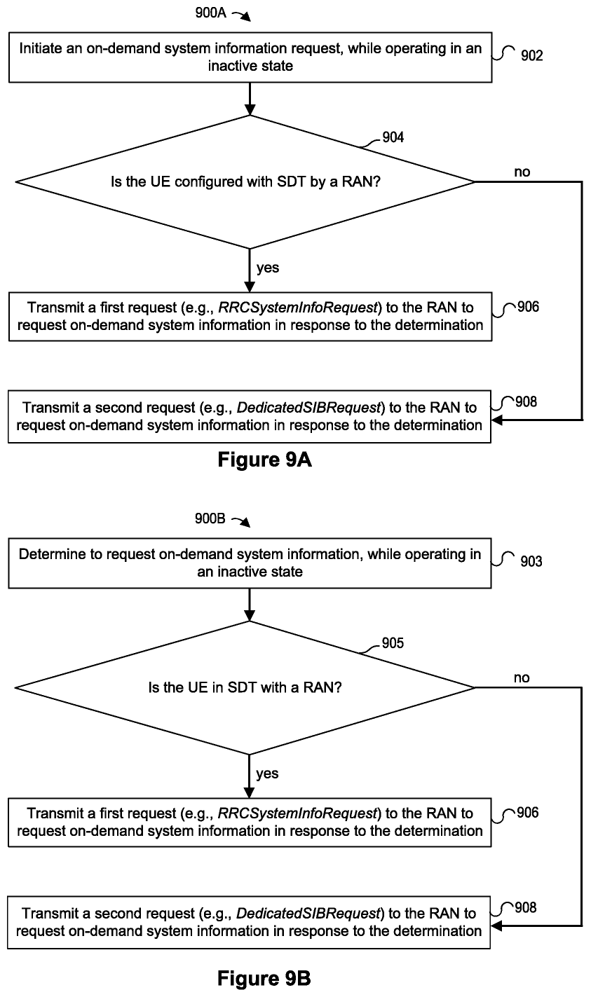

Turning to FIG. 9A, a UE (e.g., the UE 102) can implement an example method 900A to transmit a system information request to a RAN (e.g., the RAN 105, base station 104/106, CU 172, CU-CP 172A), while operating in the inactive state.

The method 900A begins at block 902, where the UE initiates an on-demand system information request, while operating in an inactive state (e.g., event 318). At block 904, the UE determines whether the UE is configured with SDT by a RAN. If the UE determines that the UE is configured with SDT, the flow proceeds to block 906. At block 906, the UE transmits a first request to the RAN to request on-demand system information in response to the determination (e.g., event 320, 319). Otherwise, if the UE determines that the UE is not configured with SDT, the flow proceeds to block 908. At block 908, the UE transmits a second request to the RAN to request on-demand system information in response to the determination (e.g., event 321).

Turning to FIG. 9B, a UE (e.g., the UE 102) can implement an example method 900B to transmit a system information request to a RAN (e.g., the RAN 105, base station 104/106, CU 172, CU-CP 172A), while operating in the inactive state.

The method 900B begins at block 903, where the UE initiates an on-demand system information request, while operating in an inactive state (e.g., event 318). At block 905, the UE determines whether the UE is in SDT with a RAN (i.e., whether the UE has an SDT session with the RAN). If the UE determines that the UE is in SDT with the RAN, the flow proceeds to block 906. At block 906, the UE transmits a first request to the RAN to request on-demand system information in response to the determination (e.g., event 320, 319). Otherwise, if the UE determines that the UE is not in SDT with the RAN, the flow proceeds to block 908. At block 908, the UE transmits a second request to the RAN to request on-demand system information in response to the determination (e.g., event 321).

Turning to FIG. 10, a RAN node (e.g., the base station 104/106, CU 172, CU-CP 172A, or DU 174) can implement an example method 1000 to transmit system information to a UE (e.g., the UE 102), while the UE operates in an inactive state.

The method 1000 begins at block 1002, where the RAN node performs data communication with a UE operating in an inactive state (i.e., during a SDT session) (e.g., events 314, 316). At block 1004, the RAN node receives a system information request for on-demand system information from the UE during the data communication (i.e., during the SDT session) (e.g., events 319, 320, 321, 322, 349, 350, 351, 352). At block 1006, the RAN node transmits system information to the UE via unicast or broadcast in response to the system information request (e.g., events 322, 323).

In some implementations, the RAN node can transmit the system information during the data communication. In other implementations, the base station can transmit the system information after stopping the data communication.

Turning to FIG. 11, a CU (e.g., the CU 172) can implement an example method 1100 to transmit system information to a UE (e.g., the UE 102) via a DU (e.g., the DU 174), while the UE operates in an inactive state.

The method 1100 begins at block 1102, where the CU performs data communication with a UE operating in an inactive state via the DU (e.g., events 314, 316). At block 1104, the CU receives a system information request for on-demand system information from the UE via the DU during the data communication (e.g., events 319, 320, 321, 322, 349, 350, 351, 352). At block 1106, the CU transmits a CU-to-DU message to the DU to command the DU to broadcast system information, in response to the system information request.

In some implementations, the system information includes one or more SIBs. The system information request includes information indicating the SIB(s) requested by the UE. In some implementations, the CU can include the requested SIB(s) in the CU-to-DU message. In other implementations, the CU can include the information indicating the requested SIB(s) in the CU-to-DU message and the DU generates and broadcasts the requested SIB(s) in accordance with the information. In yet other implementations, the SIB(s) includes first SIB(s) and second SIB(s). The CU can generate the first SIB(s). In the CU-to-DU message, the CU can include the first SIB(s) and information indicating the second SIB(s). In such cases, the DU broadcast the first SIB(s) received from the CU and generate and broadcast the second SIB(s) in accordance with the information.

Turning to FIG. 12, a CU (e.g., the CU 172) can implement an example method 1200 to transmit system information to a UE (e.g., the UE 102) via a DU (e.g., the DU 174), while the UE operates in an inactive state.

The method 1200 begins at block 1202, where the CU performs data communication with a UE operating in an inactive state via the DU (e.g., events 314, 316). At block 1204, the CU receives a system information request for on-demand system information from the UE via the DU during the data communication (e.g., events 319, 320, 321, 322, 349, 350, 351, 352). At block 1206, the CU generates a dedicated message including system information requested by the UE in the system information request. At block 1208, the CU transmits a CU-to-DU message including the dedicated message to the DU.

In some implementations, the system information includes one or more SIBs. The system information request includes information indicating the SIB(s) requested by the UE. In some implementations, the CU can generate the requested SIB(s) and include the SIB(s) in the CU-to-DU message. In other implementations, the CU can receive a DU-to-CU message including the requested SIB(s). In yet other implementations, the SIB(s) includes first SIB(s) and second SIB(s). The CU can generate the first SIB(s). The CU can receive a DU-to-CU message including the second SIB(s) from the DU. In some implementations, the CU can transmit to the DU a second CU-to-DU message, e.g., to request the second SIB(s). In such cases, the DU transmits the DU-to-CU message in response to the second CU-to-DU message. In other implementations, the DU can proactively transmit the DU-to-CU message to the CU.

In some implementations, the dedicated message is an RRC reconfiguration message. In such cases, the CU can receive an RRC reconfiguration complete message from the UE via the DU. In other implementations, the dedicated message can be a new RRC message.

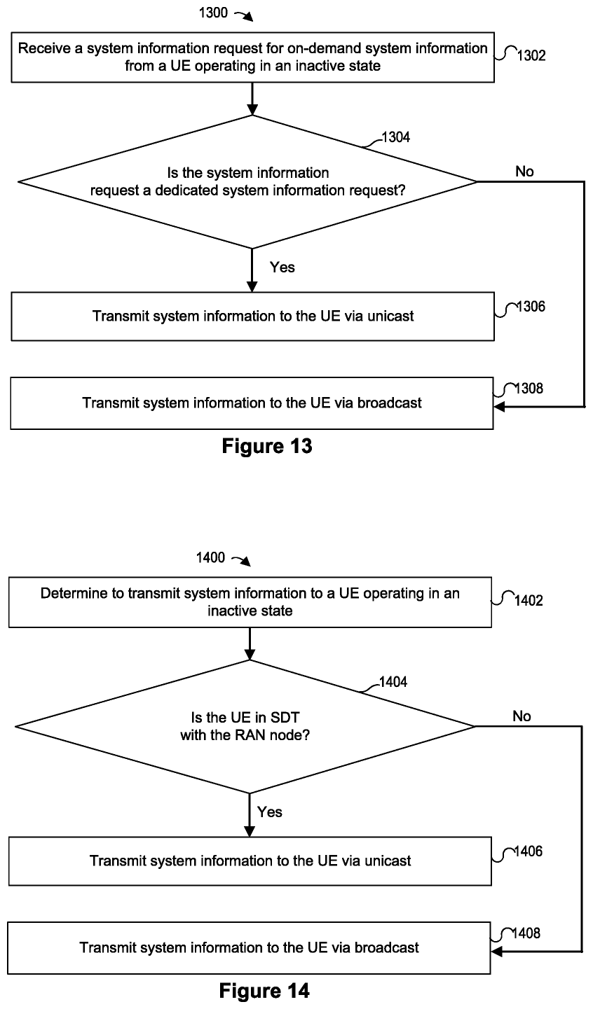

Turning to FIG. 13, a RAN node (e.g., the base station 104/106, CU 172, CU-CP 172A, or DU 174) can implement an example method 1300 to transmit system information via unicast or broadcast to a UE (e.g., the UE 102), while the UE operates in an inactive state.

The method 1300 begins at block 1302, where the RAN node receives a system information request for on-demand system information from a UE operating in an inactive state (e.g., events 315, 317, 319, 320, 321, 322, 349, 350, 351, 352). At block 1304, the RAN node determines whether the system information request is a dedicated system information request (e.g., RRC dedicated SI request message). If the RAN node determines that the system information request is a dedicated system information request, the flow proceeds to block 1306. At block 1306, the RAN node transmits system information to the UE via unicast (e.g., event 323). Otherwise, if the RAN node determines that the system information request is not a dedicated system information request (e.g., the system information request is an RRC SI request message), the flow proceeds to block 1308. At block 1308, the RAN node transmits system information to the UE via broadcast (e.g., event 322).

Turning to FIG. 14, a RAN node (e.g., the base station 104/106, CU 172, CU-CP 172A, or DU 174) can implement an example method 1400 to transmit system information via unicast or broadcast to a UE (e.g., the UE 102), while the UE operates in an inactive state.

The method 1400 begins at block 1402, where the RAN node determines to transmit system information to a UE operating in an inactive state. At block 1404, the RAN node determines whether the UE is in SDT with the RAN node (i.e., whether the UE has a SDT session with the RAN node). If the RAN node determines that the UE is in SDT with the UE, the flow proceeds to block 1406. At block 1406, the RAN node transmits system information to the UE via unicast (e.g., event 323). Otherwise, if the RAN node determines that the UE is not in SDT with the RAN node, the flow proceeds to block 1408. At block 1408, the RAN node transmits system information to the UE via broadcast (e.g., event 322).

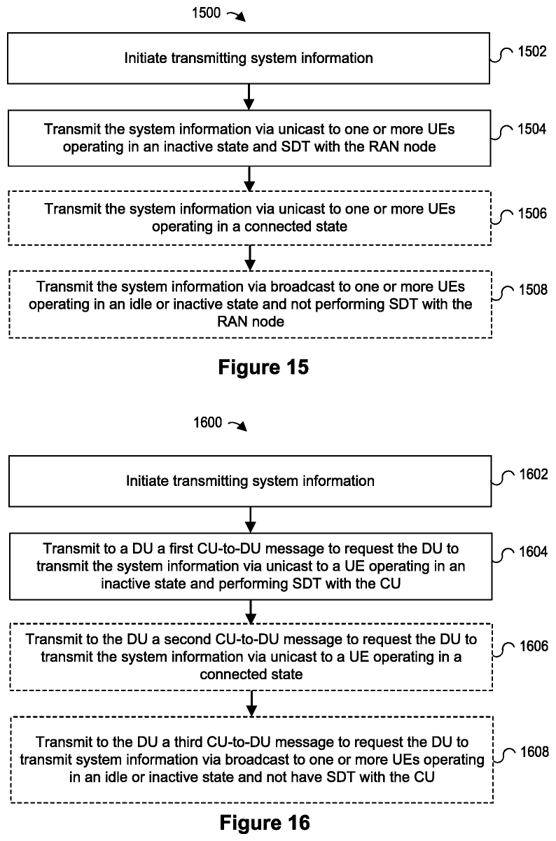

Turning to FIG. 15, a RAN node (e.g., the base station 104/106, CU 172, CU-CP 172A, or DU 174) can implement an example method 1500 to transmit system information via unicast or broadcast to one or more UEs (e.g., including the UE 102).

The method 1500 begins at block 1502, where the RAN node initiates transmitting system information. At block 1504, the RAN node transmits the system information via unicast to one UEs operating in an inactive state and SDT with the RAN node (e.g., event 323). At block 1506, the RAN node can optionally transmit the system information via unicast to one or more UEs operating in a connected state. At block 1508, the RAN node can optionally transmit the system information via broadcast to one or more UEs that are operating in an idle or inactive state and are not performing SDT with the RAN node.

In some implementations, the RAN node transmits a RRC reconfiguration message including the system information via unicast to each of one or more UEs operating in a connected state. The each of the UE(s) transmits a RRC reconfiguration complete message to the RAN node in response to the RRC reconfiguration message.

Turning to FIG. 16, a CU (e.g., the CU 172) can implement an example method 1600 to transmit system information via unicast or broadcast to one or more UEs (e.g., including the UE 102).

The method 1600 begins at block 1602, where the CU initiates transmitting system information. At block 1604, the CU transmits to a DU (e.g., the DU 174) a first CU-to-DU message to request that the DU transmit the system information via unicast to a UE operating in an inactive state and performing SDT with the CU. At block 1606, the CU can optionally transmit to the DU a second CU-to-DU message, to request that the DU transmit the system information via unicast to a UE operating in a connected state. At block 1608, the CU transmits to the DU a third CU-to-DU message, to request that the DU transmit system information via broadcast to one or more UEs that are operating in an idle or inactive state and are not performing SDT with the CU.

In some implementations, the first and second CU-to-DU messages can be the same CU-to-DU message (i.e., the same instance). In other implementations, the first and second CU-to-DU messages can be different CU-to-DU messages (i.e., different instances or messages).

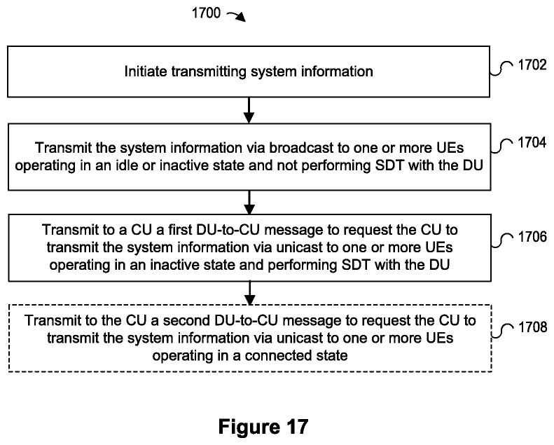

Turning to FIG. 17, a DU (e.g., the CU 174) can implement an example method 1700 to transmit system information via unicast or broadcast to one or more UEs (e.g., including the UE 102).

The method 1700 begins at block 1702, where the DU initiates transmitting system information. At block 1704, the DU transmits the system information via broadcast to one or more UEs that are operating in an idle or inactive state and are not performing SDT with the DU. At block 1706, the DU transmits to a CU a first DU-to-CU message to request that the CU transmit the system information via unicast to one or more UEs operating in an inactive state and performing SDT with the DU. At block 1708, the DU can optionally transmit to the CU a second DU-to-CU message to request that the CU transmit the system information via unicast to one or more UEs operating in a connected state.

In some implementations, the first and second DU-to-CU messages can be the same DU-to-CU message (i.e., the same instance). In other implementations, the first and second DU-to-CU messages can be different DU-to-CU messages (i.e., different instances or messages).

The following list of examples reflects a variety of the implementations explicitly contemplated by the present disclosure:
Example 1. A method, performed by a user equipment (UE), of obtaining system information, the method comprising: communicating with a radio access network (RAN) while the UE is in an inactive state with small data transmission (SDT) enabled; disabling a system information request function of the UE while the UE is in the inactive state with SDT enabled; and enabling the system information request function of the UE when the UE is no longer in the inactive state with SDT enabled.
Example 2. The method of example 1, further comprising: before the communicating, initiating the SDT, wherein the disabling occurs after the initiating and before the communicating.
Example 3. The method of example 2, wherein the disabling occurs in response to the initiating.
Example 4. The method of any one of examples 1-3, further comprising: after the communicating, stopping the SDT, wherein the enabling occurs after the stopping.
Example 5. The method of example 4, wherein the enabling occurs in response to the stopping.
Example 6. The method of any one of examples 1-5, further comprising: initiating, while the UE is in the inactive state with SDT enabled, a system information request; and in response to initiating the system information request, (i) stopping the SDT and (ii) requesting system information from the RAN.
Example 7. The method of any one of examples 1-6, wherein the system information request function is an on-demand system information request function.
Example 8. A user equipment (UE) comprising processing hardware and configured to perform the method of any one of examples 1-7.
Example 9. A method, performed by a user equipment (UE), of obtaining system information, the method comprising: communicating with a radio access network (RAN) while the UE is in an inactive state with small data transmission (SDT) enabled; transmitting, while the UE is in the inactive state with SDT enabled, a system information request to the RAN; and in response to the system information request, receiving system information from the RAN.
Example 10. The method of example 9, wherein the system information request is a radio resource control (RRC) message in an uplink (UL) medium access control (MAC) protocol data unit (PDU).
Example 11. The method of example 10, wherein the system information request is an RRCSystemInfoRequest message.
Example 12. The method of example 11, wherein the receiving includes receiving the system information via a broadcast transmission by the RAN.
Example 13. The method of example 10, wherein the system information request is a dedicated RRC system information request message.
Example 14. The method of example 13, wherein the receiving includes receiving the system information via a broadcast transmission by the RAN.
Example 15. The method of example 13, wherein the receiving includes receiving the system information via a unicast transmission by the RAN.
Example 16. The method of example 9, wherein transmitting the system information request includes transmitting a message of a random access channel (RACH) procedure in accordance with a RACH configuration dedicated for system information requests.
Example 17. The method of example 16, wherein transmitting the system information request includes transmitting the message of the RACH procedure using a RACH preamble dedicated for system information requests.
Example 18. The method of example 16 or 17, wherein the receiving includes receiving the system information via a broadcast transmission by the RAN.
Example 19. The method of any one of examples 9-18, further comprising: initiating the SDT, wherein the transmitting and the receiving occur after the initiating and before the communicating.
Example 20. The method of example 19, further comprising: determining to request system information; and before the transmitting, suspending data transmission, wherein the suspending, the transmitting, and the receiving occur in response to the determining.
Example 21. The method of any one of examples 9-20, wherein the system information request is a request for on-demand system information.
Example 22. A user equipment (UE) comprising processing hardware and configured to perform the method of any one of examples 9-21.
Example 23. A method, performed by one or more nodes of a radio access network (RAN), of providing system information, the method comprising: communicating with a user equipment (UE) while the UE is in an inactive state with small data transmission (SDT) enabled; receiving, while the UE is in the inactive state with SDT enabled, a system information request from the UE; and in response to the system information request, transmitting system information to the UE.
Example 24. The method of example 23, wherein the system information request is a radio resource control (RRC) message in an uplink (UL) medium access control (MAC) protocol data unit (PDU).
Example 25. The method of example 24, wherein the system information request is an RRCSystemInfoRequest message.
Example 26. The method of example 25, wherein the transmitting includes broadcasting the system information.
Example 27. The method of example 24, wherein the system information request is a dedicated RRC system information request message.
Example 28. The method of example 27, wherein the transmitting includes broadcasting the system information.
Example 29. The method of example 27, wherein the transmitting includes unicasting the system information.
Example 30. The method of any one of examples 27-29, wherein the transmitting is in response to the system information request being a dedicated RRC system information request message.
Example 31. The method of example 23, wherein receiving the system information request includes receiving a message of a random access channel (RACH) procedure transmitted by the UE using a RACH configuration dedicated for system information requests.
Example 32. The method of example 31, wherein the message of the RACH procedure includes a RACH preamble dedicated for system information requests.
Example 33. The method of example 31 or 32, wherein the transmitting includes broadcasting the system information.
Example 34. The method of example 23, wherein: the one or more nodes include a central unit (CU) of a base station of the RAN; the communicating includes communicating, by the CU, with the UE via a distributed unit (DU) of the base station; and the receiving includes receiving, by the CU, the system information request via the DU.
Example 35. The method of example 34, wherein the transmitting includes transmitting, by the CU, a CU-to-DU message to the DU to command the DU to broadcast the system information.
Example 36. The method of example 34, further comprising: generating, by the CU, a dedicated message including the system information, wherein the transmitting includes transmitting, by the CU, a CU-to-DU message including the dedicated message.
Example 37. The method of example 23, wherein the transmitting includes unicasting the system information in response to determining that the UE is in SDT.
Example 38. The method of any one of examples 23-37, wherein the system information request is a request for on-demand system information.
Example 39. A method, performed by one or more nodes of a radio access network (RAN), of providing system information, the method comprising: when communicating with at least a first user equipment (UE) in an inactive state with small data transmission (SDT) enabled, unicasting system information to at least the first UE; when communicating with at least a second UE in an inactive state without SDT enabled, broadcasting system information to at least the second UE; and when communicating with at least a third UE in a connected state, unicasting system information to at least the third UE.
Example 40. The method of example 39, wherein: the one or more nodes include a central unit (CU) of a base station of the RAN; unicasting system information to at least the first UE includes transmitting, by the CU, a first CU-to-DU message to request that a distributed unit (DU) of the base station unicast system information to at least the first UE; broadcasting system information to at least the second UE includes transmitting, by the CU, a second CU-to-DU message to request that the DU broadcast system information to at least the second UE; and unicasting system information to at least the third UE includes transmitting, by the CU, a third CU-to-DU message to request that the DU unicast system information to at least the third UE.
Example 41. The method of example 39, wherein: the one or more nodes include a distributed unit (DU) of a base station of the RAN, the base station also including a central unit (CU); unicasting system information to at least the first UE includes transmitting, by the DU, a first DU-to-CU message to request that the CU unicast system information to at least the first UE; broadcasting system information to at least the second UE is performed by the DU; and unicasting system information to at least the third UE includes transmitting, by the DU, a second DU-to-CU message to request that the CU unicast system information to at least the third UE.
Example 42. A node of a radio access network (RAN) comprising processing hardware and configured to perform the method of any one of examples 23-41.

The following description may be applied to the description above.

In some implementations, “message” is used and can be replaced by “information element (IE)”, and vice versa. In some implementations, “IE” is used and can be replaced by “field”, and vice versa. In some implementations, “configuration” can be replaced by “configurations” or “configuration parameters”, and vice versa. In some implementations, “small data transmission” can be replaced by “early data transmission (EDT)” and “SDT” can be replaced by “EDT”, and vice versa. In some implementations, “small data transmission” can be replaced by “small data communication”, and vice versa. In some implementations, “communicating data via RB(s)” can be replaced by “communicate data associated to RB(s)” or “communicate data on RB(s),” and “communicate” can be replaced by “transmit,” “receive.” or “transmit and receive”. In some implementations, the CU-to-DU message(s) and CU-to-DU message(s) can be F1 application protocol (F1AP) message(s), e.g., defined in 3GPP specification 38.473. In some implementations, the CU-to-DU message(s) and CU-to-DU message(s) can be UE-associated message(s) or non-UE-associated message(s). For example, the CU-to-DU message(s) and CU-to-DU message(s) can be UE-associated message(s) in the case of “unicast”, and the CU-to-DU message(s) and CU-to-DU message(s) can be non-UE-associated message(s) in the case of “broadcast”.

A user device in which the techniques of this disclosure can be implemented (e.g., the UE 102) can be any suitable device capable of wireless communications such as a smartphone, a tablet computer, a laptop computer, a mobile gaming console, a point-of-sale (POS) terminal, a health monitoring device, a drone, a camera, a media-streaming dongle or another personal media device, a wearable device such as a smartwatch, a wireless hotspot, a femtocell, or a broadband router. Further, the user device in some cases may be embedded in an electronic system such as the head unit of a vehicle or an advanced driver assistance system (ADAS). Still further, the user device can operate as an internet-of-things (IoT) device or a mobile-internet device (MID). Depending on the type, the user device can include one or more general-purpose processors, a computer-readable memory, a user interface, one or more network interfaces, one or more sensors, etc.

Certain embodiments are described in this disclosure as including logic or a number of components or modules. Modules may can be software modules (e.g., code stored on non-transitory machine-readable medium) or hardware modules. A hardware module is a tangible unit capable of performing certain operations and may be configured or arranged in a certain manner. A hardware module can comprise dedicated circuitry or logic that is permanently configured (e.g., as a special-purpose processor, such as a field programmable gate array (FPGA) or an application-specific integrated circuit (ASIC)) to perform certain operations. A hardware module may also comprise programmable logic or circuitry (e.g., as encompassed within a general-purpose processor or other programmable processor) that is temporarily configured by software to perform certain operations. The decision to implement a hardware module in dedicated and permanently configured circuitry, or in temporarily configured circuitry (e.g., configured by software) may be driven by cost and time considerations.

When implemented in software, the techniques can be provided as part of the operating system, a library used by multiple applications, a particular software application, etc. The software can be executed by one or more general-purpose processors or one or more special-purpose processors.

1. A method, performed by a user equipment (UE), of obtaining system information, the method comprising:
disabling a system information request function of the UE while the UE is in an inactive state;
while the system information request function is disabled and the UE is in the inactive state, communicating with a radio access network (RAN) using small data transmission (SDT);
initiating, during the communicating, a system information request; and
in response to initiating the system information request, (i) stopping SDT with the RAN and (ii) requesting system information from the RAN, wherein requesting the system information from the RAN includes enabling the system information request function of the UE when the UE is no longer communicating with the RAN using SDT.

2. The method of claim 1, further comprising:
before the communicating, initiating SDT with the RAN,
wherein the disabling occurs after the initiating and before the communicating.

3. The method of claim 2, wherein the disabling occurs in response to initiating the SDT with the RAN.

4. The method of claim 1, further comprising:
after the communicating, stopping the SDT with the RAN,
wherein the enabling occurs after the stopping.

5. The method of claim 4, wherein the enabling occurs in response to the stopping.

6. The method of claim 1, wherein the enabling occurs while the UE is in the inactive state.

7. The method of claim 1, wherein the disabling prevents any system information request procedure from interrupting or delaying the communicating.

8. The method of claim 1, wherein the disabling prevents the UE from transmitting, to the RAN during the communicating, a radio resource control (RRC) system information request message, a random access preamble for a system information request, or an RRC dedicated system information request message.

9. (canceled)

10. The method of claim 1, wherein the system information request function is an on-demand system information request function.

11. A user equipment (UE) comprising processing hardware and configured to:
disable a system information request function of the UE while the UE is in an inactive state;
while the system information request function is disabled and the UE is in the inactive state, communicate with a radio access network (RAN) using small data transmission (SDT);
initiate, during the communicating, a system information request; and
in response to initiating the system information request, (i) stop SDT with the RAN and (ii) request system information from the RAN, wherein requesting the system information from the RAN includes enabling the system information request function of the UE when the UE is no longer communicating with the RAN using SDT.

12. The UE of claim 11, wherein the UE is further configured to:
before the communicating, initiate SDT with the RAN,
wherein the disabling occurs after the initiating and before the communicating.

13. The UE of claim 12, wherein the disabling occurs in response to initiating the SDT with the RAN.

14. The UE of claim 11, wherein the UE is further configured to:
after the communicating, stop the SDT with the RAN,
wherein the enabling occurs after the stopping.

15. The UE of claim 14, wherein the enabling occurs in response to the stopping.

16. The UE of claim 11, wherein the enabling occurs while the UE is in the inactive state.

17. The UE of claim 11, wherein the disabling prevents any system information request procedure from interrupting or delaying the communicating.

18. The UE of claim 11, wherein the disabling prevents the UE from transmitting, to the RAN during the communicating, a radio resource control (RRC) system information request message, a random access preamble for a system information request, or an RRC dedicated system information request message.
